(19) United States
(12) Patent Application Publication
(10) Pub. No.: US 2019/0118943 A1
(43) Pub. Date: Apr. 25, 2019

(54) Tail-Sitter Aircraft With Hybrid Propulsion

(71) Applicant: General Atomics Aeronautical Systems, Inc., San Diego, CA (US)

(72) Inventors: James Thomas Machin, Wrightwood, CA (US); Robert Daniel Love, Hesperia, CA (US); Michael David Stroup, Victorville, CA (US)

(21) Appl. No.: 15/792,490

(22) Filed: Oct. 24, 2017

(51) Int. Cl. B64C 29/02

(52) U.S. Cl. CPC B64C 29/02; B64D 27/02

(57) ABSTRACT

Features for a tail-sitter aircraft having efficiently designed propulsive elements are disclosed. The aircraft may have a tail with landing mounts to support the aircraft in a vertical position for takeoff and landing. The aircraft may have a hybrid propulsion system including an electric power source, such as a generator and an electric motor, and a prime power subsystem, such as an internal combustion engine. The electric and prime power subsystems may be used controllably in varying amounts depending on the phase of flight, such as takeoff, horizontal flight, landing, or maneuvers. The aircraft may have blades with piezo elements to provide shape-changing capability to the blade. The shape of the blade, such as the pitch and/or twist, may be controllably changed for optimal efficiency with the blade depending on phase of flight. The blade shape may be changed from a rotor-like shape during takeoff and landing, to a propeller-like shape during horizontal flight.

### BACKGROUND

### Field

This development relates to aircraft and aircraft propulsion systems. In particular, features for tail sitter aircraft with hybrid electric/internal combustion propulsion systems are described.

### Description of the Related Art

A tail-sitter is a type of vertical takeoff and landing (VTOL) aircraft. A tail-sitter takes off from a vertical position sitting upright on the tail, rotates horizontally for forward flight, and then rotates back to vertical for landing on the tail. Some of these tail-sitters are unmanned, being flown remotely via remote control and with no pilot onboard. Because the power requirements for the different flight phases of VTOL aircraft (vertical takeoff, horizontal flight, vertical landing) vary drastically, conventional approaches to propulsion systems are inefficient. Therefore, VTOL tail-sitters with propulsion systems that overcome these drawbacks are desired.

### SUMMARY

The embodiments disclosed herein each have several aspects no single one of which is solely responsible for the disclosure's desirable attributes. Without limiting the scope of this disclosure, its more prominent features will now be briefly discussed. After considering this discussion, and particularly after reading the section entitled “Detailed Description” one will understand how the features of the embodiments described herein provide advantages over existing approaches to tail-sitter aircraft.

Described herein are embodiments of a tail sitter aircraft for efficient flight. One embodiment of the aircraft includes a hybrid electric propulsion system for rotating propellers to generate thrust. A prime power subsystem, such as diesel etc., is coupled with an electric power source and storage, such as an electric generator and battery. The components of the hybrid electric propulsion system are selectively used to generate thrust by rotating blades. Selection of the components of the hybrid electric propulsion system is based on various parameters, such as required power, flight regime (takeoff, landing, horizontal flight, etc.), and others.

Another embodiment of the aircraft includes shape-changing aircraft blades. The blades change shape based on various parameters of the system, such as required power, flight regime (takeoff, landing, horizontal flight, etc.), and others. The blades are selectively induced to controllably change shape using piezo elements, which may be piezoelectric. The change in shape alters the span-wise distribution of twist in the blade, i.e. a local pitch along the span of the blade, and thus the amount of thrust generated for a given speed of rotation of the blade. In some embodiments, the aircraft incorporates either the hybrid electric propulsion system or the shape-changing blades. In some embodiments, the aircraft incorporates both the hybrid electric propulsion system and the shape-changing blades.

In a first aspect, a hybrid propulsion system for a tail-sitter aircraft is described. The hybrid propulsion system comprises a propeller, an electrical power subsystem, an electrical energy store and a prime power subsystem. The propeller is configured to provide vertical lift to the aircraft during vertical takeoff and vertical landing phases and to provide horizontal thrust to the aircraft during a horizontal flight phase. The electrical power subsystem is coupled with the propeller and is configured to supply increased electrical power to rotate the propeller at a first speed during the vertical takeoff and vertical landing phases and to supply reduced electrical power to rotate the propeller at a second speed during the horizontal flight phase, where the first speed is greater than the second speed. The electrical energy store is coupled with the electrical power subsystem and is configured to provide electrical energy to the electrical power subsystem during the vertical takeoff and landing phases and to store electrical energy produced by the electrical power subsystem during the horizontal flight phase. The prime power subsystem is coupled with the electrical power subsystem and is configured to supply increased prime power to the electrical power subsystem during the vertical takeoff and vertical landing phases and to supply reduced prime power to the electrical power subsystem during the horizontal flight phase.

In some embodiments, the electrical power subsystem comprises a generator coupled with the prime power subsystem and an electric motor coupled with the generator and with the propeller. The prime power subsystem may be configured to provide prime power to the generator for production of increased electrical power, and the generator may be configured to supply the increased electrical power to the electric motor to rotate the propeller at high speed during the vertical takeoff and vertical landing phases. The electrical energy store may be coupled with the electric motor, and the electrical energy store may be configured to provide the increased electrical energy to the electric motor during the vertical takeoff and landing phases. The electrical energy store may be coupled with the generator, and the electrical energy store may be configured to store electrical energy produced by the generator during the horizontal flight phase.

In some embodiments, the prime power subsystem is an internal combustion engine.

In some embodiments, the electrical power subsystem supplies a peak electrical power during the vertical takeoff and vertical landing phases.

In some embodiments, the prime power subsystem supplies a peak prime power during the vertical takeoff and vertical landing phases.

In some embodiments, the electrical and prime power subsystems are configured to collectively produce a first total output of power for liftoff that is at least two times a second total output of power produced for horizontal flight.

In some embodiments, the electrical power subsystem comprises a generator coupled with the prime power subsystem and an electric motor coupled with the generator and with the propeller. The prime power subsystem is configured to provide prime power to the generator for production of increased electrical power, and the generator is configured to supply the increased electrical power to the electric motor to rotate the propeller at the first speed during the vertical takeoff and vertical landing phases. The electrical energy store is coupled with the electric motor, and the electrical energy store is configured to provide the increased electrical energy to the electric motor during the vertical takeoff and landing phases. The electrical energy store is coupled with the generator, and the electrical energy store is configured to store electrical energy produced by the generator during the horizontal flight phase. The electrical power subsystem supplies a peak electrical power during the vertical takeoff and vertical landing phases. The prime power subsystem supplies a peak prime power during the vertical takeoff and vertical landing phases. The electrical and prime power subsystems are configured to collectively produce a first total output of power for liftoff that is at least two times a second total output of power produced for horizontal flight.

In some embodiments, the propeller comprises a piezo element configured to receive an electric current to change the shape of a propeller blade based on the phase of flight. An increased twist of the blade may be induced by the piezo element for horizontal flight relative to takeoff and landing.

In another aspect, a tail-sitter aircraft is described. The tail-sitter aircraft comprises a fuselage, a wing and a hybrid propulsion system. The fuselage has a nose end and a tail end, and the aircraft is configured to be oriented on the ground with the nose end pointing away from the ground. The wing is coupled with the fuselage and is configured to provide lift during a horizontal flight phase. The hybrid propulsion system comprises a propeller, an electrical power subsystem, an electrical energy store and a prime power subsystem. The electrical power subsystem is coupled with the propeller and is configured to supply increased electrical power during vertical takeoff and vertical landing phases and to supply reduced electrical power during the horizontal flight phase. The electrical energy store is coupled with the electrical power subsystem and is configured to provide electrical energy to the electrical power subsystem and to store electrical energy produced by the electrical power subsystem. The prime power subsystem is coupled with the electrical power subsystem and is configured to supply increased prime power during the vertical takeoff and vertical landing phases and to supply reduced prime power during the horizontal flight phase.

In some embodiments, the propeller is configured to provide vertical lift to the aircraft during the vertical takeoff and vertical landing phases and to provide horizontal thrust to the aircraft during a horizontal flight phase. In some embodiments, the electrical and prime power subsystems are configured to collectively rotate the propeller at a relatively higher speed during the vertical takeoff and vertical landing phases and to collectively rotate the propeller at a relatively lower speed during the horizontal flight phase. In some embodiments the electrical energy store provides electrical energy during the vertical takeoff and landing phases and stores electrical energy during the horizontal flight phase. In some embodiments, the electrical power subsystem comprises a generator coupled with the prime power subsystem and an electric motor coupled with the generator and with the propeller, where the prime power subsystem is configured to provide prime power to the generator for production of increased electrical power, and where the generator is configured to supply the increased electrical power to the electric motor to rotate the propeller at high speed during the vertical takeoff and vertical landing phases.

In some embodiments, the electrical energy store is coupled with the electric motor, and wherein the electrical energy store is configured to provide the increased electrical energy to the electric motor during the vertical takeoff and landing phases. In some embodiments, the electrical energy store is coupled with the generator, and wherein the electrical energy store is configured to store electrical energy produced by the generator during the horizontal flight phase. In some embodiments, the electrical power subsystem supplies a peak electrical power during the vertical takeoff and vertical landing phases. In some embodiments, the prime power subsystem supplies a peak prime power during the vertical takeoff and vertical landing phases. In some embodiments, the electrical and prime power subsystems are configured to collectively produce a first total output of power for liftoff that is at least two times a second total output of power produced for horizontal flight.

In another aspect, a method of control for a tail-sitter aircraft is described. The method comprises supplying a first and second prime power from a prime power subsystem to an aircraft engine during, respectively, takeoff/landing and horizontal flight, and supplying a first and second electric power from an electric power source to the aircraft engine during, respectively, takeoff/landing and horizontal flight. A first sum equal to the sum of the first prime and electric powers is greater than a second sum equal to the sum of the second prime and electric powers. The first sum is sufficient to provide vertical lift in an amount at least equal to a force due to gravity on the aircraft, and the second sum is sufficient to sustain horizontal flight. In some embodiments, the first sum is at least two times larger than the second sum. The first sum may be about 300 horsepower. The second sum may be about 60 horsepower.

In some embodiments, the method further comprises changing the shape of a propeller blade of the aircraft to a first twist for takeoff and landing, and changing the shape of the propeller blade to a second twist for horizontal flight, where the second twist is greater than the first twist. In some embodiments, changing the shape of the propeller blade comprises supplying a current to a piezo element coupled with the blade.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through use of the accompanying drawings. In the following detailed description, reference is made to the accompanying drawings, which form a part hereof In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and make part of this disclosure.

FIG. 1 is a top perspective view of an embodiment of a tail-sitter aircraft having a hybrid propulsion system, comprising electric and prime power subsystems, and shape-changing aircraft blades with piezo elements.

FIG. 2 is a top perspective view of the tail-sitter aircraft of FIG. 1, with the body of the aircraft shown transparently so that portions of the hybrid propulsion system are visible.

FIG. 3 is a top view of the prime power subsystem of the tail-sitter aircraft of FIG. 1, with the body of the aircraft shown transparently so that portions of the prime power subsystem are visible.

FIGS. 4A-4E are schematics of various embodiments of hybrid propulsion system configurations, having electric and prime power subsystems, that may be used with the tail-sitter aircraft of FIG. 1.

FIG. 5 is a flowchart showing an embodiment of a method for operating the hybrid propulsion system of the tail-sitter aircraft of FIG. 1 for vertical takeoff, horizontal flight, and vertical landing.

FIG. 6A is a flowchart showing an embodiment of a method for operating the hybrid propulsion system of the tail-sitter aircraft of FIG. 1 that may be used for the vertical takeoff and landing phases of flight.

FIG. 6B is a flowchart showing an embodiment of a method for operating the hybrid propulsion system of the tail-sitter aircraft of FIG. 1 that may be used for the horizontal flight phase.

FIGS. 7A-7C are perspective views of an embodiment of shape-changing aircraft blades in a first configuration having a first twist that may be used with the tail-sitter aircraft of FIG. 1 for the horizontal flight phase.

FIGS. 7D-7F are perspective views of the shape-changing aircraft blades of FIGS. 7A-7C in a second configuration having a second twist that may be used with the tail-sitter aircraft of FIG. 1 for the vertical takeoff and landing phases of flight.

FIGS. 8A and 8B are graphical representations showing, respectively, embodiments of blade chord distributions and blade twist distributions that may be incorporated into the shape-changing aircraft blades of FIGS. 7A-7F.

FIG. 9A is a cross-section view of one of the shape-changing aircraft blades of FIGS. 7A-7F showing a piezo element embedded in the blade and in mechanical communication with a composite member of the blade.

FIG. 9B is a partial cross-section view of one of the shape-changing aircraft blades of FIGS. 7A-7F with some features removed for clarity to show the piezo element, composite member, and primary spar.

FIG. 10A is a schematic of one of the shape-changing aircraft blades of FIGS. 7A-7F showing portions of the blade which may have the shape changed for various control techniques.

FIG. 10B is a schematic showing various control techniques that may be performed with the tail-sitter aircraft of FIG. 1.

FIG. 11 is a plot showing an embodiment of a flight profile for the tail-sitter aircraft of FIG. 1.

FIG. 12 is a flowchart showing an embodiment of a method for operating the shape-changing aircraft blades of the tail-sitter aircraft of FIG. 1 in flight.

FIG. 13 is a flowchart showing an embodiment of a method for operating the hybrid propulsion system and the shape-changing aircraft blades of the tail-sitter aircraft of FIG. 1 in flight.

FIGS. 14A-14C are various views of another embodiment of a tail-sitter aircraft having a hybrid propulsion system, comprising electric and prime power subsystems, and shape-changing aircraft blades with piezo elements.

### DETAILED DESCRIPTION

The following detailed description is directed to certain specific embodiments of the development. Reference in this specification to “one embodiment,” “an embodiment,” or “in some embodiments” means that a particular feature, structure, or characteristic described in connection with the embodiment is included in at least one embodiment of the invention. The appearances of the phrases “one embodiment,” “an embodiment,” or “in some embodiments” in various places in the specification are not necessarily all referring to the same embodiment, nor are separate or alternative embodiments necessarily mutually exclusive of other embodiments. Moreover, various features are described which may be exhibited by some embodiments and not by others. Similarly, various requirements are described which may be requirements for some embodiments but may not be requirements for other embodiments.

Various embodiments of the development will now be described with reference to the accompanying figures, wherein like numerals refer to like elements throughout. The terminology used in the description presented herein is not intended to be interpreted in any limited or restrictive manner, simply because it is being utilized in conjunction with a detailed description of certain specific embodiments of the development. Furthermore, embodiments of the development may include several novel features, no single one of which is solely responsible for its desirable attributes or which is essential to practicing the invention described herein.

Vertical-takeoff and landing (VTOL) aircraft have challenging requirements, including power and lift requirements. For instance, internal combustion engines can be sized to provide the high power demand of the takeoff and landing phases, but that sizing results in unnecessary extra power and weight for the horizontal flight phase. Electric propulsion systems provide high power more efficiently, but have insufficient power capacity to provide the necessary endurance and/or payload lifting capacity. A hybrid propulsion system as described herein is ideal to supply both: (1) high power by combining peak prime power and stored electrical energy for a short period of time for VTOL and (2) reduced power from the small prime power subsystem during the slower, long-duration horizontal or loiter phase. Although hybrid power sources have traditionally been considered more complicated (and therefore less reliable) and also undesirably heavier, the design of the hybrid-propulsion system described herein provides for a lower weight propulsion system than previously used for conventional VTOL tail-sitter aircraft. In addition, the hybrid power system described herein may make the aircraft more reliable, since it can provide power for engine-out emergency landings and enable bursts of speed to increase platform responsiveness.

Tail-sitter aircraft have seen limited application since manned configurations have suffered poor reliability. However, advances in controls and increased capabilities of unmanned systems reduced the risk of transitioning between horizontal and vertical flight. Tail-sitters offer the ability to takeoff and land vertically with minimal penalties to the aircraft configuration, but require high output power on takeoff and landing for short durations. The hybrid-propulsion systems described herein mitigate this remaining limitation by providing peak power for takeoff/landing with minimum increase to the aircraft empty weight.

Vertical-takeoff and landing (VTOL) aircraft also have challenging lift requirements with respect to propellers. As used herein, unless otherwise indicated explicitly or by context, the terms “propeller,” “blade,” and “rotor” may be used interchangeably. An aircraft blade, such as a propeller, rotor, etc., converts rotary motion from an engine or other mechanical power source, to provide propulsive forces such as lift during vertical takeoff or thrust during horizontal flight. It comprises a rotating power-driven hub, to which several radial airfoil-section blades are attached, such that the whole assembly rotates about a longitudinal axis. The propeller attaches to the power source's driveshaft either directly or through reduction gearing. The twist of the blade defines a series of localized pitches along the span of the blade, where the span extends from an inner hub to the outer tip of the blade. The pitch of a propeller blade refers to turning the angle of attack of the aircraft blades into or out of the wind to control the production or absorption of power. The blade pitch may be described as “coarse” for a coarser angle and “fine” for a finer angle. The blade pitch may be described in units of distance/rotation assuming no slip. Low pitch yields good low speed acceleration (and climb rate in an aircraft) while high pitch optimizes high speed performance and economy. The pitch may be altered by changing the shape of the blade by altering the amount of twist while keeping the root of the blade fixed. The pitch may also be altered by rotating the entire blade along an axis extending along the span of the blade, such as by rotating the blade at the root. This rotation does not change the shape of the blade but rather rotates the entire blade while maintaining the shape. Both twist inducement to change the shape and pitch changes via blade rotation may be simultaneously incorporated.

A propeller blade's propulsive output, such as lift or thrust, depends on the angle of attack combined with its speed. Because the velocity of a propeller blade varies from the inner end or hub to the outer end or tip, it has a twisted form in order for the propulsive output to remain approximately constant along the length of the blade; this is called washout. Varying the pitch in flight may give optimum thrust over the maximum amount of the aircraft's speed range, from takeoff and climb to cruise.

The geometries of efficient propellers and rotors are fundamentally different from one another due to the difference in the angle and speed of incoming air. Embodiments of shape-changing blades described herein facilitate the ability of the blade to behave like an efficient rotor. In addition, the variations in geometry will enable the blade to efficiently address variations in air density as the aircraft changes altitude. Some embodiments of the blade provide a variable-geometry propeller structural configuration, along with a sensing and control method designed to provide efficient transition and flight throughout flight regimes including vertical or horizontal takeoff, horizontal flight, and landing. The shape-changing blade structural configuration described herein also adapts well to varying air density.

Some embodiments provide a variable-pitch blade which changes twist using actuation generated with the piezoelectric effect to such an extent that it may also act as an efficient rotor which provides cyclic and collective control. Some embodiments provide a novel placement of the piezoelectric material on the blade planform and within the internal structure to amplify the deflections, and thereby the overall twist of the blade. Some embodiments enable a blade shaped initially like a typical propeller, which is typically inefficient during takeoff and landing due to low advance ratios, to perform as efficiently as a helicopter rotor on takeoff and landing. Some embodiments also provide information regarding aeroelastic blade deflections such that the blade geometry can be adjusted to maintain efficient flight in various flight conditions.

Embodiments of the variable-geometry aircraft blades described herein may be used on a “tail-sitter” aircraft that takes off and lands vertically sitting on its tail with its nose pointing upward. Thus, the blades may be used as rotors for takeoff (similar to helicopter) and as a propeller for sustained flight (similar to typical airplane), with the blades changing shape as needed during these flight regimes.

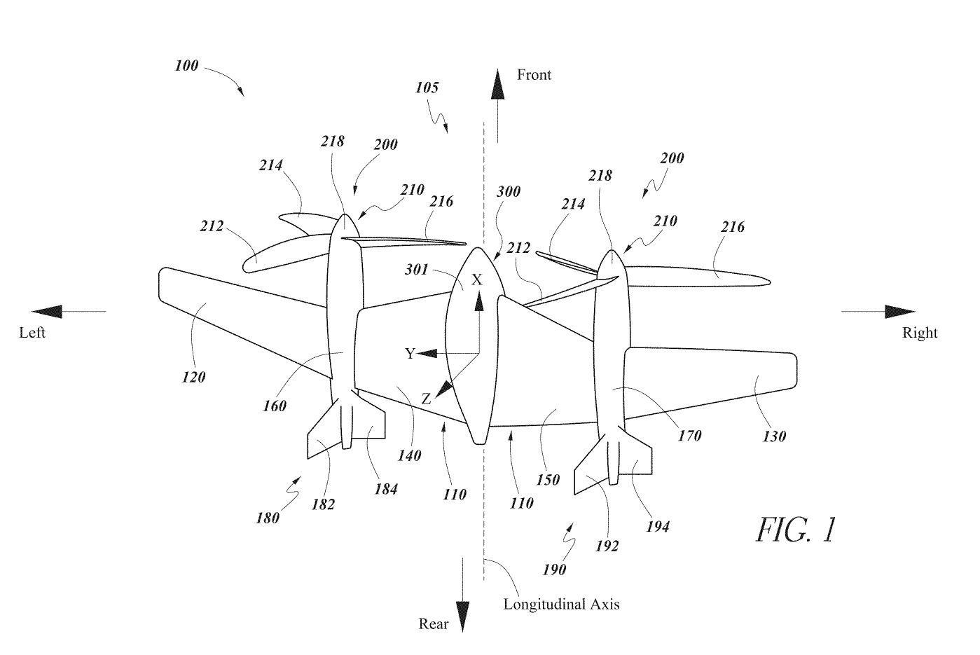

FIG. 1 is a top perspective view of an embodiment of a tail-sitter aircraft 100. The aircraft 100 is considered “tail sitter” because it can take off and land vertically with its tail on the ground. In some embodiments, other structures instead of or in addition to the tail may support the aircraft 100 on the ground, such as the wings, ground supports, and/or other structures. The term “tail sitter” includes all of these embodiments. The aircraft 100 has a hybrid propulsion system 105 that includes an electrical power subsystem 200 and a prime power subsystem 300, as described herein. The hybrid propulsion system 105 includes two electrical power subsystems 200 each operatively connected to the prime power subsystem 300 and to respective shape-changing aircraft blade assemblies 210. The blade assemblies 210 each include respective blades having features for changing geometric shape, such as the piezo elements as described herein. The prime power subsystem 300 is operatively connected to the electrical power subsystems 200 to provide a hybrid propulsion power source to controllably rotate the aircraft blade assemblies 210. In some embodiments, there may only be one aircraft blade assembly 210 or more than two aircraft blade assemblies 210. In some embodiments, there may only be one electrical power subsystem 200 or more than two electrical power subsystems 200. In some embodiments, there may be more than one prime power subsystem 300.

For ease of description only, an X-Y-Z axis system is shown in FIG. 1. The positive X, Y and Z directions are indicated by the axes as shown. The positive X direction points in the front direction of the aircraft 100, and thus the negative X direction is toward the rear direction of the aircraft 100 which is opposite the front direction. The positive Y direction is perpendicular to the X-axis and points in the left side direction of the aircraft 100, and the negative Y direction is toward the right side direction of the aircraft 100 which is opposite the left direction. The positive Z direction is perpendicular to the X and Y axes and follows the “right hand rule” where the positive Z direction points toward the top side direction of the aircraft 100 and the negative Z direction is toward the bottom side direction of the aircraft 100 which is opposite the top side direction. The longitudinal axis of the aircraft 100 is aligned with the X-axis, as indicated in FIG. 1. The X-Y-Z axis system defines several geometric planes, for ease of description only. An X-Y plane is a plane that intersects the X and Y axes. An X-Z plane is a plane that intersects the X and Z axes. A Y-Z plane is a plane that intersects the Y and Z axes. Unless otherwise noted, “inner,” “inward,” and the like refer to directions generally toward the longitudinal axis, and “outer,” “outward,” and the like refer to directions generally away from the longitudinal axis.

The aircraft 100 can fly in vertical and horizontal flight modes. Vertical flight mode is where lift to the aircraft 100 is provided primarily from the propellers and not primarily from the wings. Vertical flight mode includes trajectories of the aircraft 100 where the longitudinal axis of the aircraft 100 is not exactly aligned with a geographic vertical or line of action of gravity. Horizontal flight mode is where lift to the aircraft 100 is provided primarily from the wings and not primarily from the propellers. Horizontal flight mode includes trajectories of the aircraft 100 where the Z axes of the aircraft 100 are not exactly aligned with a geographic vertical or line of action of gravity. There may be some overlap between the two flight modes where the aircraft 100 is simultaneously in vertical and horizontal flight mode, where lift is provided approximately equally from the propellers and the wings. Further, the aircraft 100 may be flying in vertical flight mode but in a horizontal direction, for example where the propellers are providing the primary lift but the aircraft 100 is travelling horizontally.

Each blade assembly 210 provides vertical lift to the aircraft 100 during the vertical flight phases (e.g. takeoff and landing) and provides horizontal thrust to the aircraft 100 during the horizontal flight phase. The electrical subsystems 200 and prime power subsystem 300 collectively rotate the blade assemblies 210 at a relatively higher speed during the vertical takeoff and vertical landing phases and collectively rotate the blade assemblies 210 at a relatively lower speed during the horizontal flight phase. The blade assemblies' 210 speed is measured in revolutions per minute (RPM). The blade assembly 210 acts like a rotor during the vertical flight phases and as a propeller during the horizontal flight phase.

The aircraft 100 includes a center wing 110, a left wing 120 and a right wing 130. The center, left and right wings 110, 120, 130 each provide lift to the aircraft when in the horizontal flight mode. The center wing 110 is located generally near the center of the aircraft, and may be approximately symmetric with respect to the X-Z plane. The left and right wings 120, 130 are located, respectively, to the left and right sides of the center wing 110. All or some of the center, left and right wings 110, 120, 130 may be formed from composite, metallic, other suitable materials, or combinations thereof. All or some of the center, left and right wings 110, 120, 130 may include outer skin with internal spars and/or other internal structural components. All or some of the center, left and right wings 110, 120, 130 may have a variety of external airfoil shapes that produce lift at particular angles of attack with respect to the freestream flow. In some embodiments the center wing 110 may not have such an airfoil shape, where lift is provided by the right and left wings 120, 130 only.

The center wing 110 includes a left portion 140 and right portion 150. An inner end of the left portion 140 is connected to a left side of a body 301 of the prime power subsystem 300, and the opposite, outer end of the left portion 140 is connected to a right side of the electrical power subsystem 200 that is on the left side of the aircraft 100. The body 301 forms part of a “fuselage” of the aircraft 100. The fuselage may also include the housings 160, 170 and various connected components described herein. The left wing 120 is connected to the left side of the electrical power subsystem 200 that is on the left side of the aircraft 100. An inner end of the right portion 150 is connected to a right side of the body 301 of the prime power subsystem 300, and the opposite outer end of the right portion 150 is connected to a left side of the electrical power subsystem 200 that is on the right side of the aircraft 100. The right wing 130 is connected to the right side of the electrical power subsystem 200 that is on the right side of the aircraft 100.

In some embodiments, the center wing 110 may be connected directly to the left and rights wings 120, 130. For example, there may be only one electrical power subsystem 200 located in the center of the aircraft 100. In some embodiments, there may be more than two electrical power subsystems 200 such that the center, left and/or right wings 110, 120, 130 each are composed of discrete portions interposed between the more than two electrical power subsystems 200. Thus, the configuration shown in FIG. 1 is merely one example, and other suitable configurations may be implemented.

The electrical power subsystems 200 are located in housings 160 and 170. The electrical power subsystem 200 on the left is housed inside housing 160, and the electrical power subsystem 200 on the right is housed inside housing 170. The housings 160, 170 provide structural protection and containment for various components of the respective electrical power subsystems 200. The housings 160, 170 may be formed of composite, aluminum, other metals, other suitable materials, or combinations thereof. The housings 160, 170 connect the various portions of the wings, as described above.

The housings 160, 170 are each, respectively, connected to a left and right tail 180, 190. The tails 180, 190 may be formed from the same or different materials as the housings 160, 170. The tails 180, 190 provide takeoff supports on which the aircraft 100 sits before vertical takeoff. The tails 180, 190 also provide landing supports when the aircraft 100 lands vertically. The housings 160, 170 and tails 180, 190 may form part of a “fuselage” of the aircraft 100, as described herein.

The left tail 180 includes a top vertical fin 182 and a bottom vertical fin 184. The top vertical fin 182 extends in the positive Z direction and is parallel or approximately parallel to the X-Z plane. In some embodiments, the vertical fin 180 may not be parallel or approximately parallel to the X-Z plane. The bottom vertical fin 184 extends in the negative Z direction and is parallel or approximately parallel to the X-Z plane. In some embodiments, the bottom vertical fin 184 may not be parallel or approximately parallel to the X-Z plane. The top and bottom vertical and =fins 182, 184 provide a larger footprint for the respective tails 180,190 to facilitate balance of the aircraft 100 during vertical takeoff and landing. In some embodiments, there may be more than one top vertical fin 182 and/or more than one bottom vertical fin 184. For example, there may be multiple angled top and/or bottom vertical fins 182, 184.

The right tail 190 includes a top vertical fin 192 and a bottom vertical fin 194. The tail 190 may be analogous to the tail 180, where the top vertical fin 192 is analogous to the top vertical fin 182 of the left tail 180, and the bottom vertical fin 194 is analogous to the bottom vertical fin 184 of the tail 180. By “analogous” it is meant the respective components may have the same or similar features and/or functionalities.

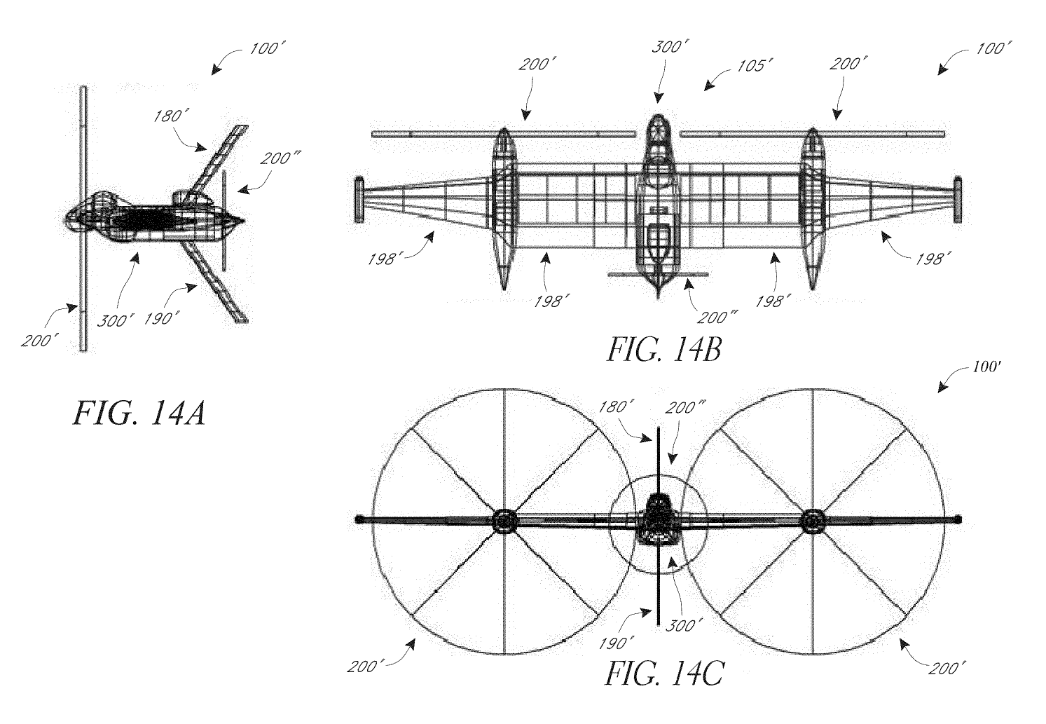

In some embodiments, there may be fewer or more than two tails 180, 190. There may only be a single tail 180 or 190, for example in the center of the aircraft 100 having only a single electrical power subsystem 200. There may be more than two tails 180 or 190, for example if there are more than two electrical power subsystems 200, as described above. Another embodiment showing an alternate configuration for a tail of the aircraft 100 is shown in FIGS. 14A-14C.

The blade assemblies 210 each include three blades 212, 214, 216. In some embodiments, each blade assembly 210 may have less than or more than three blades, such as one, two, four, five, six, seven, eight, or more blades. A hub 218 is located at the front side of each blade assembly 210 and centrally located with respect to the blades 212, 214, 216. The hub 218 is rotated by the electrical and prime power subsystems 200, 300, as described herein. The hub 218 is connected to inner ends of each of the blades 212, 214, 216. Thus, rotation of the hub 218 rotates the blades 212, 214, 216. Rotation of the blades 212, 214, 216 provides lift during vertical flight mode, such as vertical takeoff and landing, as well as thrust during horizontal flight mode, such as level flight. The blades 212, 214, 216 thus act as rotors, similar to helicopter rotors, during vertical flight mode, and act as propellers, similar to propellers on horizontal takeoff airplanes, during horizontal flight mode.

The blades 212, 214, 216 may change shape. The blades 212, 214, 216 may have a first shape for vertical flight mode, such as during vertical takeoff and landing, and another shape for horizontal flight mode, such as during level flight. The blades 212, 214, 216 may all have the same shape at the same time. In some embodiments, the blades 212, 214, 216 may vary in shape with respect to each other. In some embodiments, the blades 212, 214, 216 connected to the same hub 218 may vary in shape with respect to each other. In some embodiments, the blades 212, 214, 216 connected to the hub 218 on the left may vary in shape with respect to the blades 212, 214, 216 connected to the hub 218 on the right. The blades 212, 214, 216 may change shape using piezo elements, as described herein. Alternatively or in addition, the blades 212, 214, 216 may change shape using other devices, such as torque tubes, etc. In some embodiments, the blades 212, 214, 216 may incorporate other shape changes, such as changes to the shape of the airfoils of the blades 212, 214, 216.

In some embodiments, the blades may not change shape. For example, the aircraft 100 may include blades 212, 214, 216 that rotate along respective longitudinal axes of the respective blades. Such rotations may uniformly change the pitch of the blades 212, 214, 216 along the longitudinal span of the blades 212, 214, 216. A torque tube or other device may be used to rotate the blades. In some embodiments, the blades 212, 214, 216 may change shape as well as be rotated. In some embodiments, the blades 212, 214, 216 may not change shape or rotate, for example they may be static.

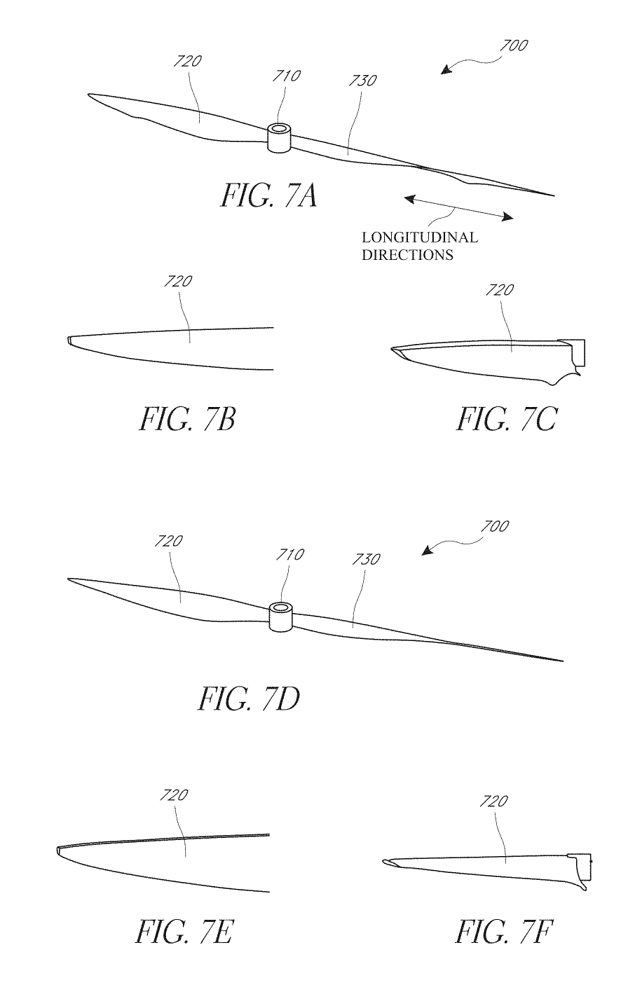

The change in shape and/or rotation of the blades 212, 214, 216 is based on required propulsive force, such as thrust or lift, from the blades 212, 214, 216. The thrust force is generated by rotation of the blades 212, 214, 216 and provides movement to the aircraft 100 in the front or positive X direction. More propulsive force from the blades 212, 214, 216 in the form of lift is required during vertical flight mode. The blades 212, 214, 216 thus have a first shape and rotational speed that provides more propulsive force during vertical flight mode and a second shape and rotational speed that provides relatively less propulsive force during horizontal flight mode. In vertical flight mode, the propulsive force from the blades 212, 214, 216 provides the primary lifting force to the aircraft 100. In horizontal flight mode, the propulsive force from the blades 212, 214, 216 provides thrust such that the wings 120, 130, 140 and/or 150 provide the primary lifting force to the aircraft 100. Further details of the shape-changing aspects of the blades 212, 214, 216 are provided herein, for example with respect to FIGS. 7A-12.

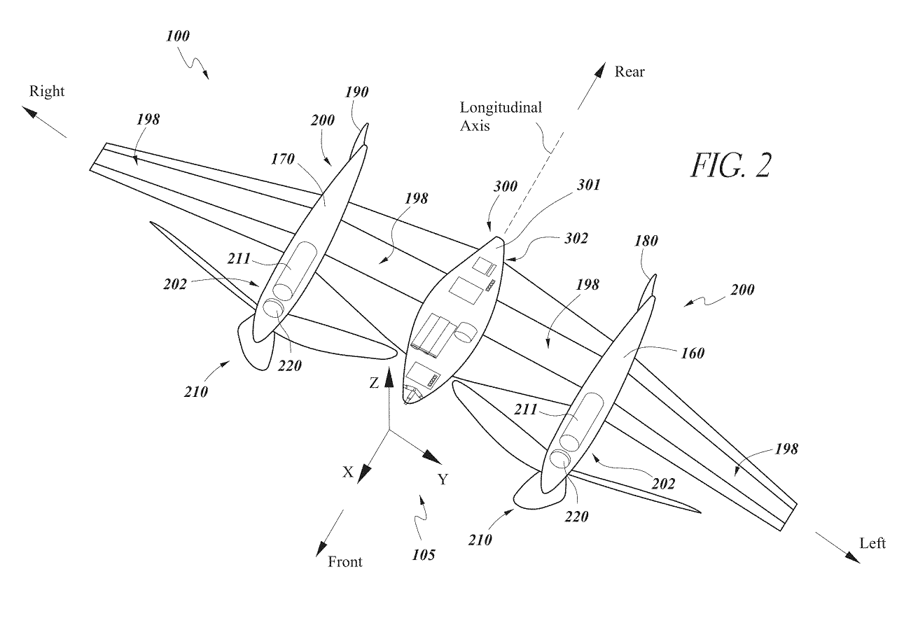

FIG. 2 is another top perspective view of the tail-sitter aircraft 100 with a hybrid propulsion system 105, with portions of the body of the aircraft 100 shown transparently for clarity. Thus, portions of the electrical power subsystems 200 and prime power subsystem 300 are visible. The electrical and prime power subsystems 200, 300 may be used controllably in varying amounts depending on the phase of flight, such as takeoff, horizontal flight, landing, or maneuvers.

The tail-sitter aircraft 100 has a fuselage that includes the body 301, a wing 198, and a hybrid propulsion system 105. The fuselage may also include the housings 160, 170 and the tails 180, 190. The fuselage has a nose end, that includes the forward portions of the components of the fuselage, and a tail end that includes the rearward portions of the components of the fuselage. In some embodiments, there may only be a single, central structure, such as the body 301, where the fuselage only includes the body 301. In some embodiments, there may be more than one body 301 and/or more than two housings 160, 170, and the fuselage would include all of these components with the nose end being the forward portions thereof and the tail end being the rearward portions thereof. The tail end and/or other features may support the aircraft 100 on the ground with the nose end oriented vertically or generally vertically. The hybrid propulsion system 105 includes the blade assembly 210, the electrical power subsystem 200 coupled with the blade assembly 210, an electrical energy store 211 coupled with the electrical power subsystem 200, and the prime power subsystem 300 coupled with the electrical power subsystem 200.

The wing 198 is coupled with the body 301. The wing 198 provides lift during the horizontal flight phase. The wing 198 extends between the body 301, which houses the prime power subsystem 300, and the housings 160, 170, which house the electrical power subsystems 200. The wing 198 extends beyond the electrical power subsystems 200. In some embodiments, the wing 198 may extend to electrical power subsystem 200 and not beyond. The wing 198 may hold fuel. The wing 198 may have one or more fuel tanks for holding fuel. The fuel type depends on the type of engine used in the prime power subsystem 300. The shape and length of the wing 198 illustrated in FIG. 2 is merely exemplary and the wing 198 can have any suitable shape and length for flight. The wing 198 can include the left wing 120, the left portion 140, the right portion 150, and the right wing 130 described with respect to FIG. 1.

Typically, the sweep of the wing 198 is about zero degrees about the quarter chord of the wing 198 for peak aerodynamic efficiency during subsonic flight and peak structural efficiency. For a tail-sitter aircraft 100, the wing sweep may have a deviation of about ±20 degrees from the baseline of zero sweep to prevent wing tip strike during takeoff and landing, to distance the outboard wing leading edge away from the downward flow induced by the blade assembly, and/or to correct the center of gravity and aerodynamic center placement. As illustrated in the embodiment in FIG. 2, the wing 198 is swept forward. In some embodiments, the wing 198 may be swept differently (e.g. straight or backward).

As illustrated in the embodiment in FIG. 2, the electrical power subsystems 200 are located inside the left and right housings 160 and 170. The positions of the electrical power subsystems 200 illustrated in FIG. 2 are merely exemplary, and the electrical power subsystems 200 could have any suitable position inside or outside the housing 160, 170 based on spacing, power, or safety concerns.

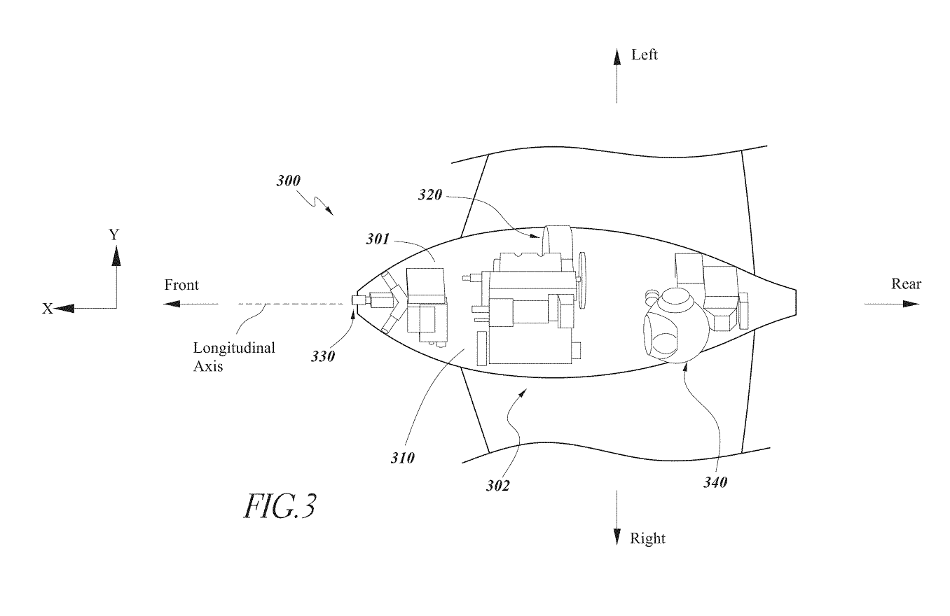

The electrical power subsystem 200 includes an electric power generation system 202. The electric power generation system 202 includes an electric motor 220 operatively connected to a generator 320 as described herein, for example as shown in and discussed with respect to FIG. 3. The electric power generation system 202 is coupled with the blade assembly 210. The electric power generation system 202 supplies an increased electrical power to rotate the blade assembly 210 at a first speed during the vertical takeoff and landing phases and a reduced electrical power to rotate the blade assembly 210 at a second speed during the horizontal flight phase. The first speed is greater than the second speed. In some embodiments, the speed during vertical takeoff is about the same as the speed during vertical landing. In some embodiments, the speed during vertical takeoff is greater or lower than the speed during vertical landing. The speed is measured as the revolutions per minute of the blade assembly. The electric power generation system 202 supplies an increased electrical power during the vertical phases than during the horizontal flight phase.

The aircraft 100 includes an energy store 211, which may be, for example, one or more battery packs. The energy store 211 can have one or more electric batteries. An electric battery can have one or more electrochemical cells, for example, alkaline, lead-acid, lithium-ion, nickel-cadmium, nickel-zinc, nickel metal hydride, zinc-carbon, or the like. The battery can be single use or rechargeable.

The energy store 211 is coupled with the electric power generation system 202. The energy store 211 provides electrical energy to the electric power generation system 202 during the vertical takeoff and landing phases, which require an increased electric power output compared to the horizontal flight phase. The energy store 211 stores electric energy produced by the electric power generation system 202 during the horizontal flight phase, which requires a reduced electric power output compared to the vertical phases. In some embodiments, the energy store 211 is considered part of the electrical power subsystem 200. In some embodiments, a generator, such as the generator 320 described herein, is considered part of the electrical power subsystem 200.

The prime power subsystem 300 may be located entirely or partially inside the body 301, for example with a “series hybrid configuration,” described herein. In other configurations, such as a “parallel hybrid configuration” described herein, the prime power subsystem 300 may be co-located with the electric power subsystem 200. The position of the prime power subsystem 300 is merely exemplary; the prime power subsystem can have any suitable position inside or outside the body 301 based on spacing, power, or safety concerns. The prime power subsystem 300 includes a prime power generation system 302. Details for the prime power subsystem 300 are shown in and discussed in greater detail herein, for example with respect to FIG. 3.

FIG. 3 is a top view of the prime power subsystem 300 with the body 301 shown transparently for clarity. The prime power subsystem 300 includes a prime power generation system 302. The prime power generation system 302 may be an engine 310, such as a combustion engine. The engine 310 can use various fuels, for example, fossil fuels, natural gas, coal, petroleum, gasoline, diesel, fuel oil, renewable fuels, biofuels, biodiesel, bioethanol, methanol, hydrogen, or the like. The engine 310 may be a diesel engine The engine 310 may be a jet engine, turbo-fan engine, turbo-prop engine, piston engine, spark ignition, compression ignition, fuel cell, or the like. In some embodiments, an efficient loiter power source is selected, such as a fuel cell or similar source where the prime power subsystem 300 is very efficient for loiter which may be incapable of providing the peak power required by VTOL, but could provide electrical power which could be leveraged by VTOL.

The prime power generation system 302 includes a generator 320. The generator 320 is operatively coupled with the engine 310 and converts the mechanical energy created by the engine 310 to electrical energy. The generator 320 may be an alternator, direct current generator, alternating current generator, induction generator, linear electric generator, variable speed constant frequency generator, or the like. In some embodiments, an alternating current (AC) motor may be used as the generator 320. In some embodiments, the generator 320 may instead or in addition be considered part of the combustion engine 310, for example, as a single unit engine-generator. In some embodiments, the generator 320 may instead or in addition be considered part of the electrical power subsystem 200, such that the electric power generation system 202 may comprise the generator 320 and the electric motor 220. Thus, the description of the generator with respect to either the electric or prime power subsystems is not limiting in that regard.

The prime power subsystem 300 may include one or more sensors 330. The sensor 330 is a sense-and-avoid assembly. The sensor 330 is able to detect and avoid intruding aircraft or objects at least within a 3 mile radius with a field of regard of 270×30 degrees. The sensor 330 is used for autonomous flight guidance, navigation, and control. In the embodiment illustrated in FIG. 3, the sensor 330 is positioned near the front of the body 301. This position is merely exemplary and the sensor 330 may be housed in other locations of the aircraft 100, for example, in the wing 198 or the housing 160 or 170. The sensor 330 may be positioned in the front, rear, top, or bottom half of the aircraft 100. The sensor 330 may have its own power source. The sensor 330 may be powered by other power sources, such as the electric power generation system 202 or energy store 211.

The prime power subsystem 300 may include one or more instruments 340, such as an optical instrument. In the embodiment illustrated in FIG. 3, the instrument 340 is shown as a laser designator, but the instrument 340 may be another type of instrument, for example, visual camera, infrared sensor, ultraviolet light sensor, night vision device, laser light, heat detector, photometer, refractometer, reflectometer, or the like. In the embodiment illustrated in FIG. 3, the instrument 340 is positioned near the rear of the body 301. This position is merely exemplary and the optical instrument 340 may be housed in other locations of the aircraft 100, for example, in the wing 198 or the housing 160 or 170. The instrument may be positioned in the front, rear, top, or bottom half of the aircraft 100.

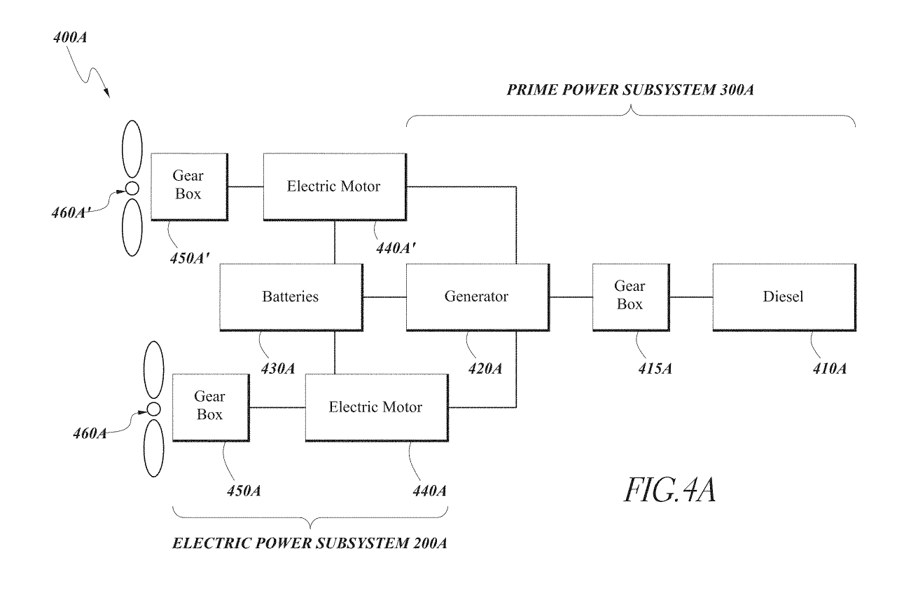

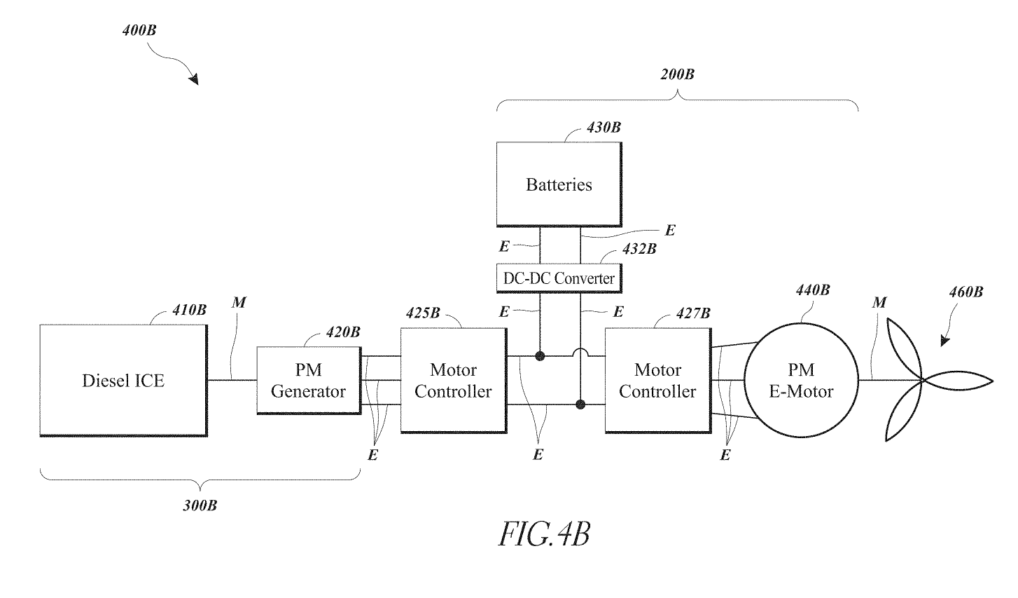

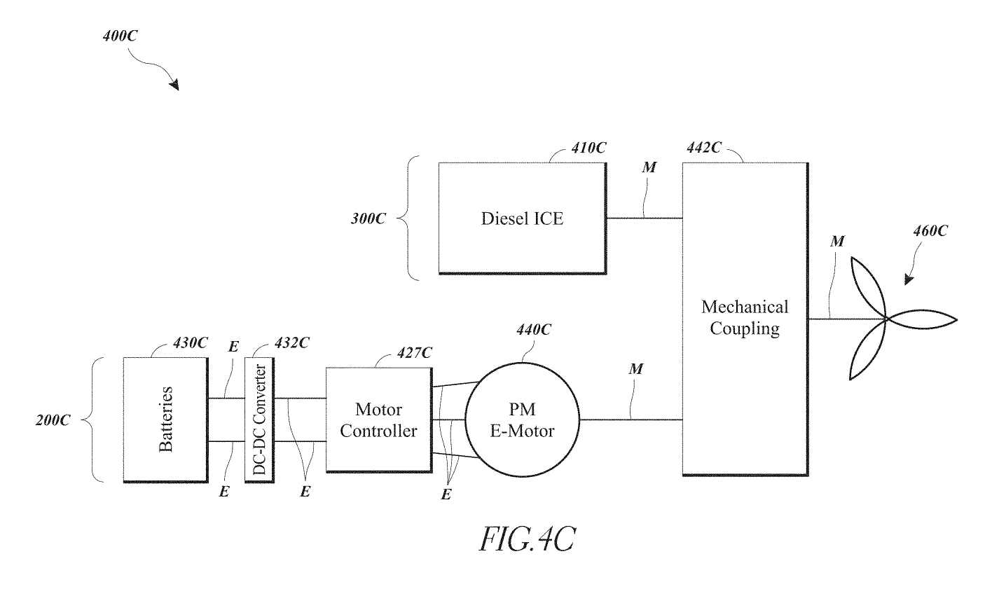

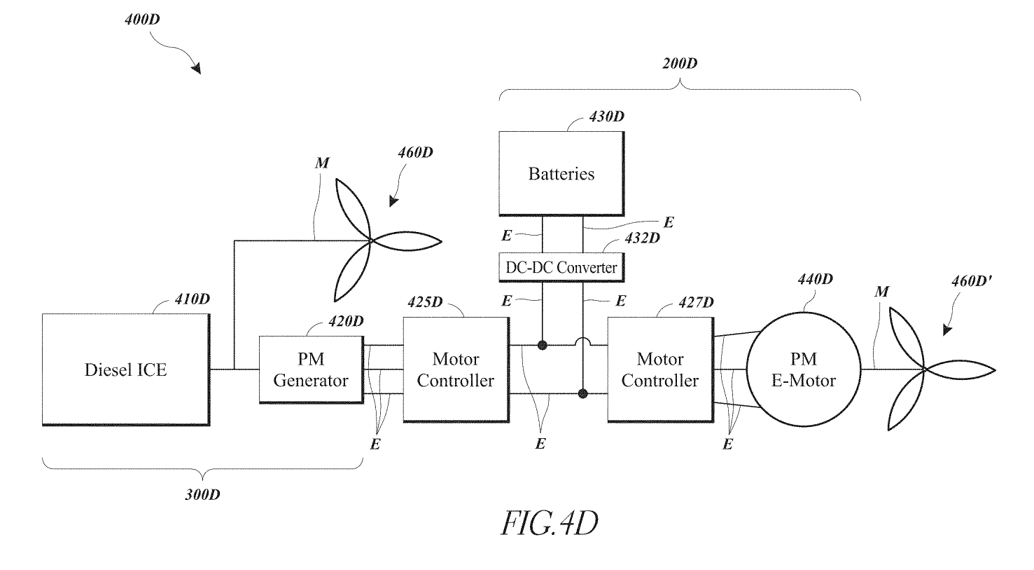

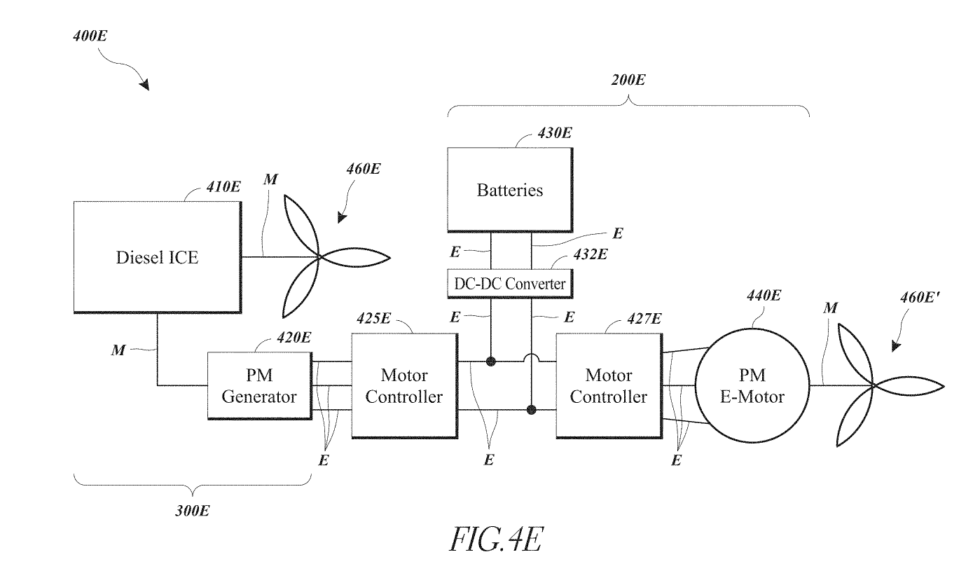

FIGS. 4A-4E are schematics of various embodiments of hybrid propulsion system configurations, having electric and prime power subsystems, that may be used with the tail-sitter aircraft 100. The various hybrid propulsion system configurations of FIGS. 4A-4E may be used as the hybrid propulsion system 105 described herein. Further, although details of the various components of each configuration may be described with respect to one or another of the configurations shown in FIGS. 4A-4E, it is understood that the components described with respect to a particular configuration may have the same or similar features as the components of the other configurations, and vice versa.

FIG. 4A is a schematic of an embodiment of a hybrid propulsion system 400A that may be used with the tail-sitter aircraft 100, for example as the hybrid propulsion system 400. The hybrid propulsion system 400A may have the same or similar features and/or functionalities as the hybrid propulsion systems 105, 400, and vice versa. The hybrid propulsion system 400A includes a prime power subsystem 300A and an electrical power subsystem 200A, as indicated. The prime power subsystem 300A and electrical power subsystem 200A may have the same or similar features and/or functionalities as, respectively, the prime power subsystem 300 and electrical power subsystem 200, and vice versa. In general, as used herein, and unless otherwise indicated explicitly or by context, callouts including a suffix such as “'” (apostrophe), “A”, “B” etc. are understood that they may have the same or similar features and/or functionalities as similar callouts having different or no suffixes, such as 300 and 300A, 200 and 200A, etc.

The prime power subsystem 300A includes an engine 410A, a gear box 415A, and a generator 420A. In FIG. 4A, the engine 410A is shown as a diesel engine, but the engine 410A may be any type of engine, for example, internal combustion engine, a jet engine, turbo-fan engine, turbo-prop engine, piston engine, spark ignition, compression ignition, fuel cell, or the like. The gearbox 415A operatively connects the engine 410A to the generator 420A. The gearbox 415A transfers the power from the engine 410A to the generator 420A. In some embodiments, the gearbox 415A may be in combination with the engine 410A and/or generator 420A. In some embodiments, the transfer of power may be done without a gearbox, such as a diesel-electric transmission or gas-electric transmission.

The electrical power subsystem includes an energy store 430A, electric motors 440A , 440A′, gearboxes 450A, 450A′, and blade assemblies 460A, 460A′ (may also be referred to as propeller or rotor), and may include the generator 420A. In some embodiments, there may be only one or more than two of the electric motor, gear box, and blade assembly. The gearboxes 450A, 450A′ may adjust the outputs from the electric motors 440A, 440A′ respectively to adjust the rotational speed for the blade assemblies 460A, 460A′ respectively, where the speed may be measured in rotations or revolutions per minute (RPM). The energy store 430A, which may be one or more batteries, is coupled to both electric motors 440A, 440A′. Each gearbox 450A, 450A′ is coupled to its own blade assembly 460A, 460A′, respectively. The blade assemblies 460A, 460A′ may be analogous to the blade assembly 210.

The electric power subsystem 200A includes the generator 420A coupled with the gear box 415A of the prime power subsystem 300A, and the generator 420A is also coupled with the electric motors 440A, 440A′ and the energy store 430A. The electric motors 440A, 440A′ are coupled with respective blade assemblies 460A, 460A′ via the respective gear boxes 450A, 450A′.

The prime power subsystem 300A provides prime power to the generator 420A for the production of electrical power. The generator 420A supplies the electrical power to the electric motors 440A, 440A′ to rotate the blade assemblies 460A, 460A′. The generator 420A supplies increased electrical power to the electric motors 440A, 440A′ to rotate the blade assemblies 460A, 460A′ at a first speed during the vertical takeoff and/or vertical landing phases. The electrical power provided by the generator 420A during vertical phases of flight is greater than the electrical power provided by the generator 420A during the horizontal or loiter phases of flight.

The generator 420A is configured to supply the increased electrical power to the electric motors 440A, 440A′ to rotate the blade assemblies 460A, 460A′ at high speed during the vertical takeoff and vertical landing phases. “High” speed is the speed relative to horizontal flight and is a speed that, along with a corresponding lower pitch (relative to horizontal flight), allows the aircraft to lift off the ground. Pitch here refers to the pitch of a section or sections of the blade, which may be changed by twist of the blade and/or by rotation of the blade to uniformly change the pitch. A higher pitch of the blade assemblies 460A, 460A′ can generate greater propulsive forces but only until portions of the blade assemblies 460A, 460A′ stall, and it thus generates that increased propulsive force with decreased overall energy efficiency since more drag is produced and therefore more power is required to rotate the blade assemblies 460A, 460A′ at a sufficiently fast speed. The greater pitch is therefore used to account for local angle of attack changes when the blade assemblies 460A, 460A′ experience increased flow velocity parallel to the axis of rotation of the blade assemblies 460A, 460A′. The blade assemblies 460A, 460A′ can thus more efficiently generate thrust with greater pitch at higher forward speeds of the aircraft 100, such as during horizontal flight, and the lower pitch is thus used during vertical takeoff and landing when the forward movement of the aircraft 100 is slower compared to horizontal flight.

The electrical energy store 430A is coupled with the electric motors 440A, 440A′. The electrical energy store 430A provides the increased electrical energy to the electric motors 440A, 440A′ during the vertical takeoff and landing phases. The blade assemblies 460A, 460A′ rotate at a higher speed during vertical takeoff and landing phases, as described, so the electric motors 440A, 440A′ require an increased electrical energy compared to the electrical energy needed during horizontal flight. The electrical energy store 430A is coupled with the generator 420A. The electrical energy store 430A stores electrical energy produced by the generator 420A during horizontal flight.

FIG. 4B is a schematic of an embodiment of a hybrid propulsion system 400B that may be used with the tail-sitter aircraft 100, for example as the hybrid propulsion system 400. The hybrid propulsion system 400B includes an electric power subsystem 200B and a prime power subsystem 300B. The configuration of the electric power subsystem 200B and the prime power subsystem 300B in the hybrid propulsion system 400B may be considered a “series hybrid” configuration. The hybrid propulsion system 400B includes an engine 410B. The engine 410 is shown as a diesel internal combustion engine, although other prime power types of engines may be used. The engine 410B may have the same or similar features and/or functionalities as the engine 410A described with respect to FIG. 4A. The engine 410B is mechanically connected with a generator 420B. The mechanical connections here and elsewhere are designated by the “M” callout. The generator 420B is shown as a permanent magnet (“PM”) generator, although other generators may be used. The generator 420B may have the same or similar features and/or functionalities as the generator 420A described with respect to FIG. 4A. The generator 420B is electrically connected to a motor controller 425B. The electrical connections here and elsewhere are designated by the “E” callout. The motor controller 425B may regulate power output from the engine 410B and generator 420B for further transmission. Various suitable controllers and control algorithms may be employed. The engine 410B, the generator 420B and the controller 425B may be connected in series, as shown. The engine 410B and the generator 420B may be part of the prime power subsystem 300B. In some embodiments, other components may be considered part of the prime power subsystem 300B, such as the controller 425B and/or other components.

The hybrid propulsion system 400B includes one or more batteries 430B. The batteries 430B may have the same or similar features and/or functionalities as the batteries 430A described with respect to FIG. 4A. The batteries 430A may be in electrical connection with a DC-DC converter 432B. The DC-DC converter 432B and the motor controller 425B may be in electrical connection with a second motor controller 427B. The second motor controller 427B may regulate the power transmitted therethrough and applied for propulsion. The second motor controller 427B is electrically connected to an electric motor 440B. The second motor controller 427B and the electric motor 440B may be connected in series as shown. The electric motor 440B may have the same or similar features and/or functionalities as the electric motors 440A, 440A′ described with respect to FIG. 4A. The electric motor 440B is shown as a permanent magnet (PM) electric motor, although other types of electric motors may be used. The electric motor 440B is mechanically connected to a blade assembly 460B. The blade assembly 460B may have the same or similar features and/or functionalities as the blade assemblies 460A, 460A′ described with respect to FIG. 4A. The batteries 430B, the DC-DC converter 432B, the motor controller 427B and the electric motor 440B may be part of the electric power subsystem 200B. In some embodiments, other components may be considered part of the electric power subsystem 200B, such as the controller 425B and/or other components.

FIG. 4C is a schematic of an embodiment of a hybrid propulsion system 400C that may be used with the tail-sitter aircraft 100, for example as the hybrid propulsion system 400. The hybrid propulsion system 400C includes an electric power subsystem 200C and a prime power subsystem 300C. The configuration of the electric power subsystem 200C and the prime power subsystem 300C in the hybrid propulsion system 400C may be considered a “parallel hybrid” configuration. The hybrid propulsion system 400C includes an engine 410C mechanically connected to a mechanical coupling 442C that drives a blade assembly 460C. The engine 410C is connected in series with the coupling 442C and in parallel to an electrical series of components of the hybrid propulsion system 400C. The engine 410C may be part of the prime power subsystem 300B. In some embodiments, other components may be considered part of the prime power subsystem 300B, such as the mechanical coupling 442C and/or other components. The prime power subsystem 300B may be configured in parallel to the electric power subsystem 200B.

The hybrid propulsion system 400C may include one or more batteries 430C, a DC-DC converter 432C, a motor controller 427C and an electric motor 440C all electrically connected in series as shown. The electric motor 440C may be mechanically coupled to the mechanical coupling 442C. Thus, the engine 410C and the electric motor 440C may both be connected in parallel to the coupling 442C to drive the blade assembly 460C. The batteries 430C, the DC-DC converter 432C, the motor controller 427C and the electric motor 440C may be part of the electric power subsystem 200C. In some embodiments, other components may be considered part of the electric power subsystem 200C, such as the mechanical coupling 442C and/or other components.

FIG. 4D is a schematic of an embodiment of a hybrid propulsion system 400D that may be used with the tail-sitter aircraft 100, for example as the hybrid propulsion system 400. The hybrid propulsion system 400D includes an electric power subsystem 200D and a prime power subsystem 300D. The configuration of the electric power subsystem 200D and the prime power subsystem 300D in the hybrid propulsion system 400B may be considered a “hybrid hybrid” configuration. The hybrid propulsion system 400D may be similar to the hybrid propulsion system 400B described with respect to FIG. 4B. However, the hybrid propulsion system 400D further includes a blade assembly 460D mechanically connected to the engine 410D. The blade assembly 460D may be connected to the engine 410D on the same shaft as a generator 420D. The single shaft may have a clutch to engage (e.g. for takeoff) or disengage (e.g. for loiter) the generator 420D. The engine 410D and the generator 420D may be part of the prime power subsystem 300D. In some embodiments, other components may be considered part of the prime power subsystem 300D, such as the controller 425D and/or other components.

The hybrid propulsion system 400D further includes a controller 425D, batteries 430D, a DC-DC converter 432D, a second controller 427D, an electric motor 440D and a second blade assembly 460D′. These components may have the same or similar features and/or functionalities as the corresponding components shown in and described with respect to FIG. 4B. The batteries 430D, the DC-DC converter 432D, the motor controller 427D and the electric motor 440D may be part of the electric power subsystem 200D. In some embodiments, other components may be considered part of the electric power subsystem 200D, such as the controller 425D and/or other components.

FIG. 4E is a schematic of an embodiment of a hybrid propulsion system 400E that may be used with the tail-sitter aircraft 100, for example as the hybrid propulsion system 400. The hybrid propulsion system 400E includes an electric power subsystem 200E and a prime power subsystem 300E. The configuration of the electric power subsystem 200E and the prime power subsystem 300E in the hybrid propulsion system 400E may be considered another type of “hybrid hybrid” configuration. The hybrid propulsion system 400E may be similar to the hybrid propulsion system 400D described with respect to FIG. 4D. However, the hybrid propulsion system 400E further includes a blade assembly 460E and a generator 420E that are each on different mechanical shafts connected to the engine 410E. The engine 410E and the generator 420E may be part of the prime power subsystem 300D. In some embodiments, other components may be considered part of the prime power subsystem 300E, such as the controller 425E and/or other components.

The hybrid propulsion system 400E further includes a controller 425E, batteries 430E, a DC-DC converter 432E, a second controller 427E, an electric motor 440E and a second blade assembly 460E′. These components may have the same or similar features and/or functionalities as the corresponding components shown in and described with respect to FIG. 4D. The batteries 430E, the DC-DC converter 432E, the motor controller 427E and the electric motor 440E may be part of the electric power subsystem 200E. In some embodiments, other components may be considered part of the electric power subsystem 200E, such as the controller 425E and/or other components.

The hybrid propulsion systems 400A, 400B, 400C, 400D or 400E may be used as the hybrid propulsion system 105. Thus, the prime power subsystems 300A, 300B, 300C, 300D or 300E may be used as the prime power subsystem 300, and the electric power subsystems 200A, 200B, 200C, 200D or 200E may be used as the electric power subsystem 200.

The prime power subsystem 300A, 300B, 300C, 300D or 300E supplies a peak or high prime power during the vertical takeoff and landing phases. The electrical power subsystem 200A, 200B, 200C, 200D or 200E supplies a peak electrical power during the vertical takeoff and vertical landing phases. The electrical power subsystem 200A, 200B, 200C, 200D or 200E and prime power subsystem 300A, 300B, 300C, 300D or 300E, respectively, collectively produce a first total output of power for liftoff that is greater than a second total output of power produced for horizontal flight. In some embodiments, the electrical and prime power subsystems collectively produce a first total output of power for liftoff that is two to eight times greater, two-and-a-half to seven times greater, five times greater, or other amounts, than a second total output of power produced for horizontal flight. In some embodiments, the electrical and prime power subsystems collectively produce a first total output of power for liftoff that is about two-and-a-half times greater than a second total output of power produced for horizontal flight for higher disk loading of the blades, for example with aircraft 100 having low ratios of lift to drag. In some embodiments, the electrical and prime power subsystems collectively produce a first total output of power for liftoff that is about eight times greater than a second total output of power produced for horizontal flight for lower disk loading of the blades, for example with aircraft 100 having high ratios of lift to drag. More power is needed during liftoff than during horizontal flight. The total output of power for liftoff is sufficient to provide vertical lift in an amount at least equal to a force due to gravity on the aircraft. In other words, the total output of power for liftoff is sufficient to lift the aircraft off the ground. “Peak” or “high” power in this context refers to a maximum or approximately maximum output of power of the prime or electric power subsystem. Thus, “peak” power may be different amounts for different sizes of prime or electric power subsystems, which may depend on the size of the aircraft. The peak power may be the maximum amount of deliverable power based on expected run time, on current fuel amount, on current electrical energy amount, on safety considerations, on design margin of the particular engines, on maximum transmissible power through conductive couplings, on the maximum rotational speed of the blade assemblies, on other suitable factors, or combinations thereof. In some embodiments, “peak” power refers to at least 75% of the maximum amount of deliverable power of the respective power subsystem. In some embodiments, “peak” power refers to at least 85%, at least 90%, at least 95% or at least 99% of the maximum amount of deliverable power of the respective power subsystem.

FIG. 5 is a flowchart showing an embodiment of a method 500 for operating a hybrid propulsion system of a tail-sitter aircraft for vertical takeoff, horizontal flight and vertical landing. The method 500 may be used with the tail sitter aircraft 100 having the hybrid propulsion system 105, 400A, 400B, 400C, 400D or 400E.

The method 500 begins with step 510 wherein the aircraft is positioned with the nose up for vertical takeoff. Step 510 may include, for example, positioning the aircraft 100 on its tails 180, 190 and/or on other structures of the aircraft 100. In step 510, the aircraft 100 may be positioned in a variety of suitable ways, including landing on the tail from a prior flight, positioned by humans and/or machines, etc. The nose may be pointing vertically or off-vertically.

The method 500 next moves to step 520 wherein a high (i.e. peak) power is supplied for a short duration from the hybrid propulsion system 105. Step 520 may include, for example, providing high power from the hybrid propulsion system 105 for takeoff. The power provided from the hybrid propulsion system 105 in step 520 for takeoff is expected to be higher than the power provided from the hybrid propulsion system 105 for horizontal flight. The duration that power is provided for takeoff in step 520 is expected to be shorter than the duration that power is provided for horizontal flight. In some embodiments of step 520, the hybrid propulsion system 105 may provide the high power using the prime power subsystem 300A, 300B, 300C, 300D or 300E, the electrical power subsystem 200A, 200B, 200C, 200D or 200E, or a combination of the prime and electrical power subsystems. In step 520, the prime power subsystem, such as the prime power subsystem 300A, 300B, 300C, 300D or 300E, and the electrical power subsystem, such as the electrical power subsystem 200A, 200B, 200C, 200D or 200E, may provide peak power. The high power provided is sufficient to rotate the blade assembly 210 at a high enough rate to lift the aircraft 100 from the ground. The duration is sufficient to lift the aircraft 100 to a desired height.

The method 500 next moves to step 530 wherein the aircraft takes off vertically. “Vertically” in step 530 includes the vertical flight phase situations described herein, such as when the blade thrust provides the primary lifting force, etc. Step 530 may include, for example, the aircraft 100 raising to a height from its position on its tails 180, 190. As the aircraft 100 takes off, the aircraft generally stays in a vertical alignment, where the front of the aircraft 100 is generally pointed away from the ground. In some embodiments, the longitudinal axis of the aircraft 100, shown in FIG. 1, stays generally vertical during takeoff. Step 530 includes the blade assembly, such as the blade assembly 210, rotating the blades thereof to produce the propulsive lifting forces.

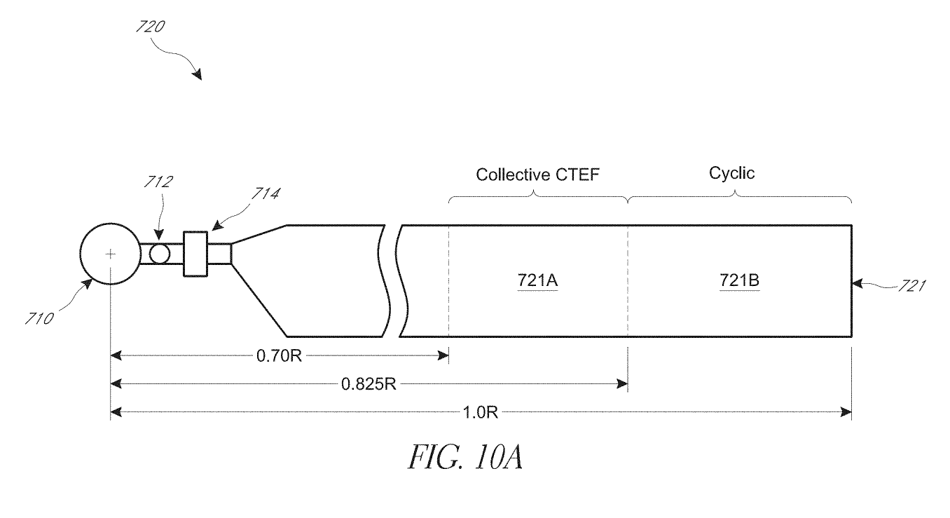

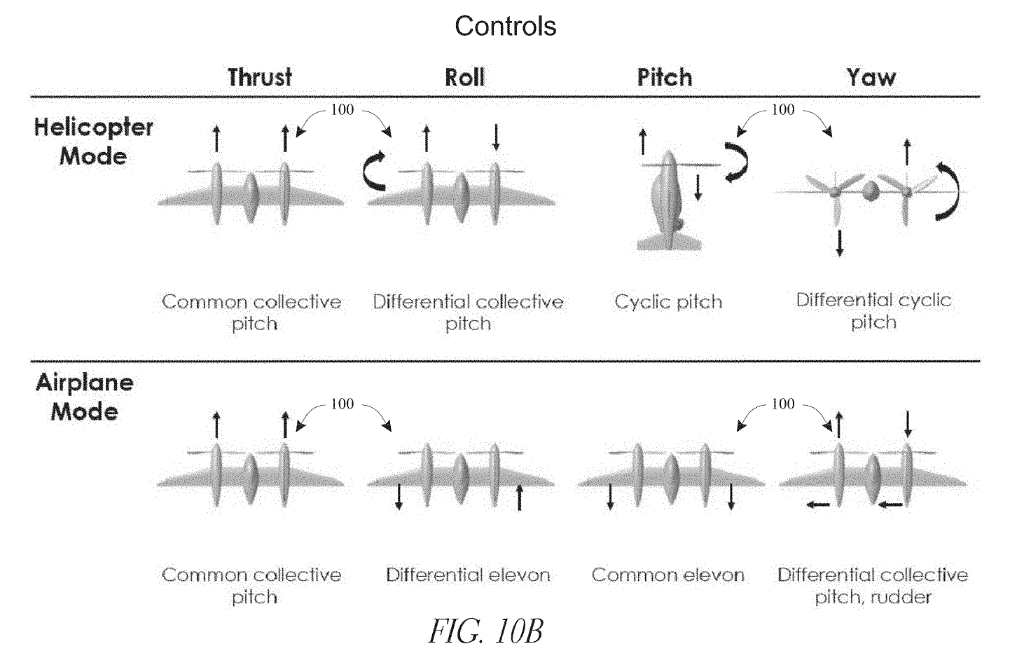

The method 500 then moves to step 540 wherein the aircraft is rotated for horizontal flight. “Horizontal” in step 540 includes the horizontal flight phase situations described herein, such as when the wings provide the primary lifting force, etc. Step 540 may include, for example, rotating the aircraft 100 from its vertical takeoff alignment to a horizontal alignment for horizontal, sustained flight. In some embodiments, the longitudinal axis of the aircraft 100, shown in FIG. 1, stays generally perpendicular to vertical during horizontal flight. The aircraft may be rotated in step 540 by cyclically altering the twist and/or pitch of the blade assemblies 210, such as with helicopter rotor flight controls, to cause a forward moment or torque on the aircraft 100 that causes it to rotate. In some embodiments, the aircraft may be rotated in step 540 by rotation of the blade assemblies, such as rotation of the hub 218 of the blade assemblies 210. Further details of how a blade may twist and thus change shape to effect rotation of the aircraft 100 in step 540 are described in further detail herein, for example with respect to FIG. 10A. The aircraft may be rotated in step 540 by using shape-changing blades and/or control surfaces of the aircraft 100. Further details of how shape-changing blades and/or control surfaces of the aircraft 100 may be used in step 540 to effect rotation of the aircraft are described in further detail herein, for example with respect to FIG. 10B.

The method 500 then moves to step 550 wherein a low power is supplied for a long duration from the hybrid propulsion system 105. Step 550 may include, for example, providing low power from the hybrid propulsion system 105 for horizontal, sustained flight. The power provided from the hybrid propulsion system 105 for horizontal flight is expected to be lower than the power provided from the hybrid propulsion system 105 for takeoff. The duration that power is provided for horizontal flight is expected to be longer than the duration that power is provided for takeoff. In some embodiments, the hybrid propulsion system 105 may provide the low power using the prime power subsystem 300A, 300B, 300C, 300D or 300E, the electrical power subsystem 200A, 200B, 200C, 200D or 200E, or a combination of the prime and electrical power subsystems. The low power provided is sufficient to keep the aircraft 100 aloft. The duration is sufficient for the aircraft 100 to go a desired distance or desired amount of time.

The method 500 then moves to step 560 wherein the aircraft flies horizontal. “Horizontal” in step 560 includes the horizontal flight phase situations described herein, such as when the wings provide the primary lifting force, etc. Step 560 may include, for example, the aircraft 100 flying in a generally level alignment. In some embodiments, the longitudinal axis of the aircraft 100, shown in FIG. 1, stays generally perpendicular to vertical during horizontal flight.

The method of 500 then moves to step 570 wherein the aircraft is rotated for vertical landing. “Vertical” in step 570 includes the vertical flight phase situations described herein, such as when the blade thrust provides the primary lifting force, etc. Step 570 may include, for example, rotating the aircraft 100 from its horizontal flying alignment to a vertical alignment for vertical landing. In some embodiments, the longitudinal axis of the aircraft 100, shown in FIG. 1, is rotated so that the front of the aircraft is pointed up and the rear of the aircraft is pointed towards the ground so that the aircraft 100 can land on its tail. The aircraft may be rotated in step 570 by cyclically altering the twist and/or pitch of the blade assemblies 210, such as with helicopter rotor flight controls, to cause a rearward moment or torque on the aircraft 100 that causes it to rotate. In some embodiments, the aircraft may be rotated in step 570 by rotation of the blade assemblies, such as rotation of the hub 218 of the blade assemblies 210. Further details of how a blade may change shapes to effect rotation of the aircraft in step 570 are described in further detail herein, for example with respect to FIG. 10A. The aircraft may be rotated in step 570 by using shape-changing blades and/or control surfaces of the aircraft 100. Further details of how shape-changing blades and/or control surfaces of the aircraft 100 may be used to effect rotation of the aircraft in step 570 are described in further detail herein, for example with respect to FIG. 10B.

The method of 500 then moves to step 580 wherein a high power is supplied for a short duration from the hybrid propulsion system 105. Step 580 may include, for example, providing peak or high power, as described herein, from the hybrid propulsion system 105 for landing. The power provided from the hybrid propulsion system 105 in step 580 for landing is expected to be higher than the power provided from the hybrid propulsion system 105 for horizontal flight. The duration that power is provided for landing in step 580 is expected to be shorter than the duration that power is provided for horizontal flight. In some embodiments, in step 580 the hybrid propulsion system 105 may provide the high power using the prime power subsystem 300A, 300B, 300C, 300D or 300E, the electrical power subsystem 200A, 200B, 200C, 200D or 200E, or a combination of the prime and electrical power subsystems. The high power provided in step 580 is sufficient to lower the aircraft 100 to the ground. The duration is sufficient for the aircraft 100 to land. The power provided and duration for landing in step 580 may be the same or substantially similar to the power provided and duration for takeoff, such as in steps 520 and 530. In some embodiments, the power provided and/or duration for landing in step 580 may be less than for takeoff In some embodiments, the power provided and/or duration for landing in step 580 may be greater than for takeoff. In some embodiments, the power provided may be of a duration sufficient for an autorotation landing only.

The method of 500 then moves to step 590 wherein the aircraft lands vertically with the nose up. Step 590 may include, for example, the tails 160, 170 of aircraft 100 touching the ground as the aircraft 100 lands in a vertical alignment. Various other configurations of the tail may be used, such as those discussed with respect to FIGS. 14A-14C. The aircraft 100 may land in step 590 without landing on the tail, for example other landing structures. The nose in step 590 may be pointing vertically up or off-vertical.

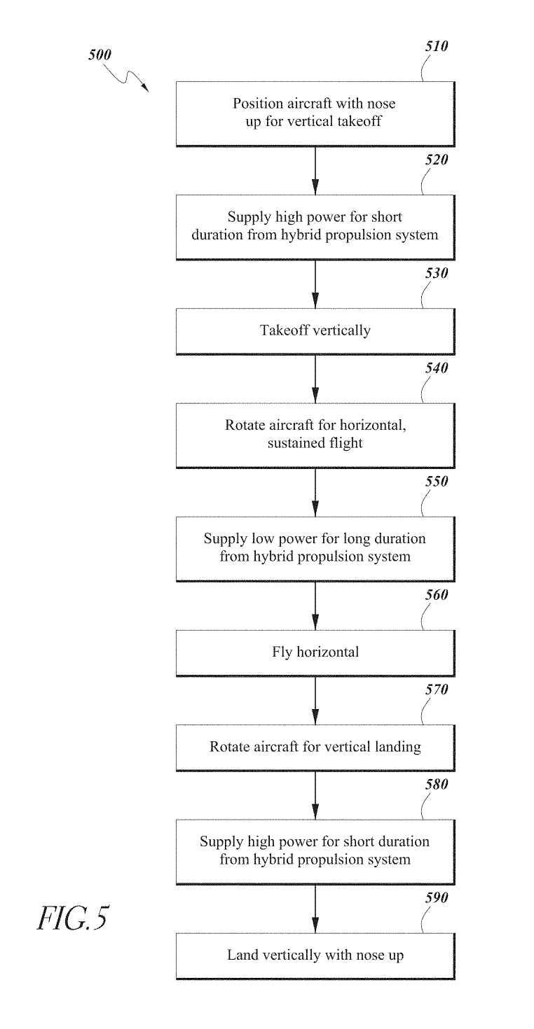

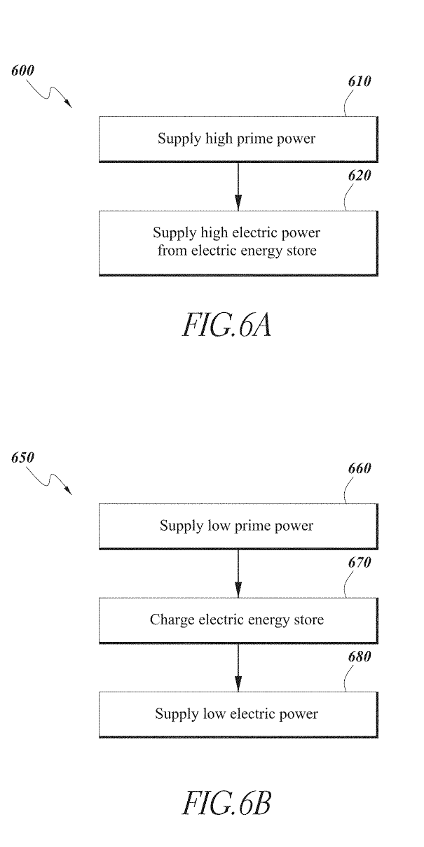

FIG. 6A is a flowchart showing an embodiment of a method 600 for operating the hybrid propulsion system 105 of the tail-sitter aircraft 100 that may be used for the vertical takeoff and landing phases of flight. The method 600 may thus be used for some of the steps of the method 500, for example the steps 520 and/or 580.

The method 600 may begin with step 610 wherein a high prime power is supplied. In some embodiments, the prime power subsystem 300A, 300B, 300C, 300D or 300E supplies a first prime power to the aircraft engine during takeoff. It is expected that the first prime power during takeoff is greater than a second prime power provided during horizontal flight because it is expected that more power is needed to generate the sufficient propulsive lifting force for takeoff.

The method 600 then moves to step 620 wherein a high electric power is supplied from the electric energy store. In some embodiments, the high electric power is supplied from the electrical power subsystem. In some embodiments, an electric power source (e.g. electrical power subsystem 200A, 200B, 200C, 200D or 200E and/or electric energy store 211) supplies a first electric power to the aircraft engine during takeoff. Steps 610 and 620 may be performed simultaneously to provide maximum power for takeoff or landing.

FIG. 6B is a flowchart showing an embodiment of a method 650 for operating the hybrid propulsion system 105 of the tail-sitter aircraft 100 that may be used for the horizontal flight phase. The method 650 may thus be used for some of the steps of the method 500, for example, the step 550.

The method 650 may begin with step 660 wherein a low prime power is supplied. In some embodiments, the prime power subsystem 300A, 300B, 300C, 300D or 300E supplies a second prime power to the aircraft engine during horizontal, sustained flight that is less than a first prime power provided for takeoff and landing.

The method 650 then moves to step 670 wherein the electric energy store is charged. In some embodiments, the generator 420A charges the energy store 430A (see FIG. 4A).

The method 650 moves to step 680 wherein a low electric power is supplied. In some embodiments, the low electric power is supplied from the electrical power subsystem. In some embodiments, the electric power source (e.g. electrical power subsystem 200A, 200B, 200C, 200D or 200E and/or electric energy store 211) supplies a second electric power to the aircraft engine during horizontal, sustained flight that is less than a first electric power provided for takeoff and landing.

The hybrid propulsion system 105 can provide varying ratios of high to low power for takeoff and landing compared to horizontal flight. In some embodiments, the power provided for each of takeoff and landing may be multiples of the power provided for horizontal flight. For example, a first sum may be the sum of the first prime power and the first electric power provided during each of takeoff or landing. A second sum may be the sum of the second prime power and the second electric power provided during horizontal flight. The first sum is sufficient to provide vertical lift in an amount at least equal to a force due to gravity on the aircraft. The second sum is sufficient to sustain horizontal flight. The first sum is greater than the second sum. The first sum may be at least one-and-a-half, two, two-and-a-half, three, four, five, six, seven, eight or more or less times larger than the second sum. The first sum may be about 300 horsepower. The second sum may be about 60 horsepower. In some embodiments, the ratio of the first sum to the second sum is in the range of from about 1.5:1 to about 8:1. The first sum for takeoff and landing may use from about 150-450 horsepower. The second sum for horizontal flight may use from about 30-90 horsepower. These are merely some examples and other amounts, proportions, ratios, etc. may be used.

FIGS. 7A-7C are perspective views of an embodiment of a blade assembly 700 having shape-changing aircraft blades 720, 730 in a first configuration having a first pitch that may be used with the tail-sitter aircraft 100. The blade assembly 700 can have one or more than two blades. FIG. 7A illustrates an embodiment with the first blade 720 and the second blade 730, both attached to a hub 710. A “longitudinal directions” double-sided arrow is indicated, showing the dimension along which the term “longitudinal length” of the blade 720 refers, as used herein. The second blade 730 may have the same or substantially similar shape as the first blade 720. The second blade 730 may have a shape different from the first blade 720. The blades 720, 730 are connected to the hub 710 such that the blades 720, 730 can alter their pitch. The blade assembly 700 may have the same or similar features and/or functionalities as the other blade assemblies described herein, such as the blade assembly 210, and vice versa.

The blades 720, 730 have a twisted form to keep the thrust constant along the length of the blade because the velocity of a blade varies from the inner end near the hub 710 to the outer, opposite end. FIG. 7B depicts a top view of the outer portion of the blade 720 in a first configuration having a first pitch. FIG. 7C depicts a side view of the same outer portion of the blade 720 in the first configuration having the first pitch.

The blades 720, 730 may be pre-stressed to maintain the twist shape. The pre-stressing also facilitates changing the pitch due to piezo elements, as described herein. For example, the material of the blades 720, 730 may be biased to bend or twist in a certain direction. Application of a shape-changing force, such as a mechanical force induced by a current supplied to a piezo element, may twist the blade 720, 730 away from the direction in which it is biased due to pre-stressing. Removal of the shape-changing force, such as removal of a mechanical force due to removal of the current supplied to the piezo element, may cause the blade 720, 730 to twist back in the direction in which it is biased due to the pre-stressing. The materials may be pre-stressed in a number of suitable manners, such as bending, cyclic loading, progressively increased loading, progressively increased cyclic loading, orientation of materials (e.g. orientation of fibers within composite materials), etc.

The blade 720 of the aircraft has a first pitch for takeoff. The shape of the blade 720 may have the same or substantially similar pitch for landing. The shape, e.g. pitch, of the blade 720 for takeoff may be different from the shape, e.g. pitch, of the blade 720 for landing. The difference between the pitch angle for takeoff and the pitch angle for landing of the blade 720 may be about 2 degrees or less. The shape of the blade 720 is at a second pitch for horizontal flight. The second pitch is greater than the first pitch. The second pitch may be about 20 degrees to about 30 degrees greater than the first pitch. The propeller (also referred to as blade assembly or rotor) provides vertical lift to the aircraft during the vertical flight phases (e.g., takeoff and landing) and provides horizontal thrust to the aircraft during the horizontal flight phase. The blade 730 may have the same or similar features and/or functionalities as the blade 720.

The electrical and prime power subsystems, described herein, collectively rotate the blade assembly 700 at a relatively higher speed during the vertical takeoff and vertical landing phases and collectively rotate the blade assembly 700 at a relatively lower speed during the horizontal flight phase. The rotational speed of the blade assembly 700 during a vertical flight phase (e.g. takeoff and landing) is greater than the rotational speed of the blade assembly 700 during the horizontal flight phase. The rotational speed of the blade assembly 700 may be measured in revolutions per minute (RPM). The blade assembly 700 may function similar to a helicopter rotor during the vertical flight phases and as a non-tail-sitter aircraft propeller during the horizontal flight phase.

The change in shape of the blade assembly 700 may alter its pitch. The blade assembly 700 may be twisted to alter the pitch. The twist may be induced by piezoelectric material located within and/or on the blade assembly 700, as described herein. The blade assembly 700 may have internal composite plies. The composite plies may be any composite material, such as carbon fiber in epoxy, graphite fiber reinforced plastic, etc. The blade assembly 700 may further include a piezoelectric actuator adjacent the composite plies, as further described herein.

Changing the pitch alters the angle of attack of the aircraft blades 720, 730 and thus the vertical acceleration or climb rate of the vehicle. This control is also called collective as distinct from the cyclic control for lateral movement. The collective blade setting may be achieved through vertical movement of a swashplate. Cyclic and collective control are described in further details herein, for example with respect to FIGS. 10A and 10B.

The blades 720, 730 may be “feathered” to increase their angle of pitch by turning the blades to be parallel to the airflow. This may minimize drag from a stopped blade 720, 730 following an engine failure in flight.

FIGS. 7D-7F are perspective views of the shape-changing aircraft blades 720, 730 in a second configuration having a second pitch that may be used with the tail-sitter aircraft 100, for example for the horizontal flight phase. FIG. 7E is a top view of the outer end of the blade 720 in a second configuration having a second pitch. FIG. 7F is a side view of the outer end of the blade 720 in a second configuration having a second pitch. Thus, the blade 720 depicted in FIGS. 7B and 7C has a greater pitch than the blade 720 depicted in FIGS. 7E and 7F.

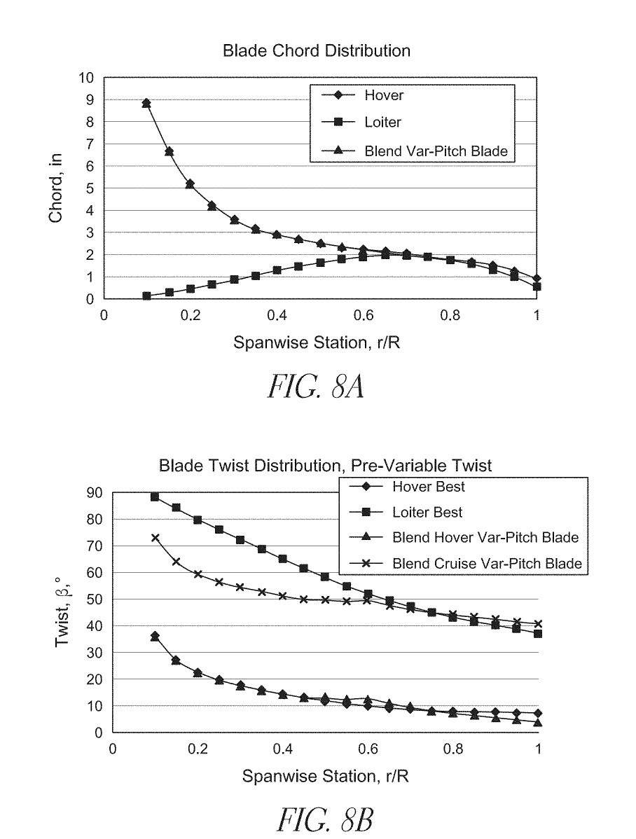

FIG. 8 is a transverse cross-section view of one of the shape-changing aircraft blades 720 having a piezo element 740. The piezo element 740 is embedded in the blade 720 and in mechanical communication with a composite member 750, as further described. While the structure and configuration of the blade 720 is discussed in detail, the same features may apply to the other blades described herein, for example the blades 212, 214, 216, 210′ and 210″.

The blade 720 changes shape in part due to a reverse piezoelectric effect of the piezo element 740. Piezoelectricity is the electric charge that accumulates in certain solid materials in response to applied mechanical stress. The piezoelectric effect may be the resulting internal electrical field generation resulting from an applied mechanical strain to a material. The piezoelectric effect may be a linear electromechanical interaction between the mechanical and the electrical state in crystalline materials. The piezoelectric effect is a reversible process, in that materials exhibiting the direct piezoelectric effect (the internal generation of electrical charge resulting from an applied mechanical force) also exhibit the reverse piezoelectric effect (the internal generation of a mechanical strain resulting from an applied electrical field). The reverse piezoelectric effect may be the resulting mechanical strain resulting from an electric current applied to or generated in a material. The reverse piezoelectric effect may be a linear electromechanical interaction between the mechanical and the electrical state in crystalline materials. As one example, lead zirconate titanate crystals will generate measurable piezoelectricity when their static structure is deformed by about 0.1% of the original dimension. Conversely, those same crystals will change about 0.1% of their static dimension when an external electric field is applied to the material.

The reverse piezoelectric effect used by the blade 720 may thus be the internal generation of a mechanical strain on the piezo element 740 resulting from an applied electrical field to the piezo element. The mechanical strain or deformation of the piezo element 740 is mechanically transmitted to the blade 720, which may be pre-stressed. The shape-changing blades described herein may utilize this reverse piezoelectric effect. For example, applying a charge to the piezo material of the piezo element 740 generates a mechanical response.

The piezo element 740 may be a piezoelectric transducer. The piezo element 740 may therefore operate as a transducer having a variety of suitable materials therein, for example to convert electrical energy, such as an applied current, into mechanical energy, such as deformation, strain, vibration, etc.

The piezo element 740 may be a Macro Fiber Composite (MFC) actuator. The piezo element 740 as MFC may include piezo ceramic rods sandwiched between layers of adhesive, electrodes and polyimide film. The piezo element 740 may be provided in the form of a thin, surface-conformable sheet and applied (e.g. bonded) to the blade 720 structure. When voltage is applied, the piezo element 740 will bend or distort, thus altering the blade 720 structure. The piezo element 740 as MFC is arranged to induce twist in the blade 720 and thus alter the pitch of the blade 720. The blade 720 may have a pitch from 0 to 24 degrees, and the induced twist may be up to 8 degrees (thus decreasing the max pitch to 16 degrees or increasing the max pitch to 32 degrees). In some embodiments, the piezo element 740 may be an Active Fiber Composite (AFC) actuator.

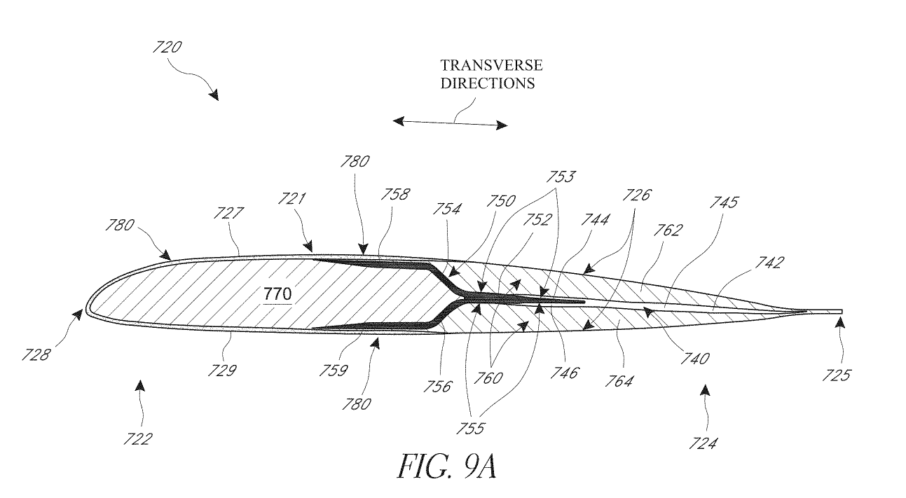

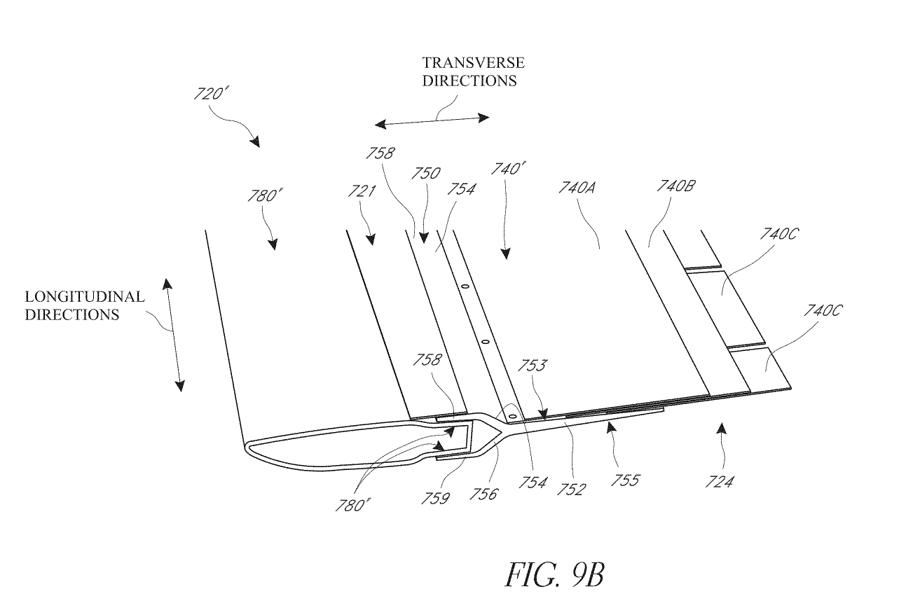

The shape-changing blade 720 has an elongated body 721 extending along a longitudinal length between an inner end and an outer end of the body 721 (as shown, e.g. in FIG. 7A and partially in FIG. 9). The longitudinal length of the body 721 of the blade 720 thus extends into and/or out of the plane of view as oriented in FIG. 8. The body 721 of the blade 720 may include the various structural features described herein with respect to the blade 720.

The blade 720 has a transverse cross-section as shown in FIG. 8 extending along a transverse length between a leading end 722 and a trailing end 724 of the body 721. The leading end 722 encounters the freestream flow before the trailing end 724 when the aircraft 100 is moving forward or up. The leading end 722 includes a leading edge 728. The trailing end 724 includes a trailing edge 725. The transverse cross-section may have a first portion that includes the trailing end 724 and the trailing edge 725, and a second portion opposite the first portion that includes the leading end 722 and the leading edge 728.

The blade 720 has a piezo element 740 embedded in the body 721. In some embodiments, the piezo element 740 is entirely embedded in the body 721. In some embodiments, the piezo element 740 is partially embedded in the body 721. The piezo element 740 extends at least partially along the longitudinal length of the body 721 and extends at least partially along the transverse length. The piezo element 740 extends at least partially within the second portion 724 of the transverse cross-section. The piezo element 740 causes the body 721 to change to a first shape when a first electrical current is supplied to the piezo element 740. The piezo element 740 causes the body 721 to change to a second shape when a second electrical current is supplied to the piezo element 740. The piezo element 740 may cause the body 721 to change to a third shape when a third electrical current is supplied to the piezo element 740. The first shape of the blade 720 is at a first pitch. The second shape of the blade 720 is at a second pitch that is greater than the first pitch. The third shape of the blade 720 is at a third pitch that may be greater or less than the first and/or second pitch. The piezo element 740 may be a piezoelectric element.

The piezo element 740 may be a single ply embedded in the body 721. The piezo element 740 may be multiple plies embedded in the body 721. The piezo element 740 extends at least partially along the transverse length within the second portion 724 of the transverse cross-section along a mean camber line defined by the body 721. The piezo element 740 may extend to a trailing edge 725 of the body 721 located within the trailing end 724.

The blade 720 may also have a composite member 750 embedded in the body 721. The composite member 750 has a first portion 752 that extends at least partially along the longitudinal length of the body 721 and extends at least partially along the transverse length. The first portion 752 may be located at least partially within the trailing end 724 of the body 721. The first portion 752 may taper, i.e. become thinner, along its length toward the trailing end 724. In some embodiments, the first portion 752 may have a uniform thickness.

The composite member 750 is in mechanical communication with the piezo element 740 such that actuation of the piezo element 740 causes the shape of the composite member 750 to change. The piezo element 740 may contact the composite member 750 such that the piezo element 740 and the composite member 750 are physically touching. The piezo element 740 may be attached to, for example bonded with, the composite member 750. In some embodiments, the composite member 750 and the piezo element 740 may be in mechanical communication but not in contact. For example, there may be intermediate structure or components between the composite member 750 and the piezo element 740. A portion of the piezo element 740 closer to the leading end 722 than to the trailing end 724 may be in mechanical communication with the composite member 750.

Various portions of the composite member 750 and piezo element 740 may be in mechanical communication. In some embodiments, the composite member 750 has a first side 753 and a second side 755. The second side 755 is opposite the first side 753. As oriented in FIG. 8, the first side 753 is located above the second side 755. The first and second sides 753, 754 of the composite member 750 may be surfaces and/or other features of the composite member 750 that are in mechanical communication with the piezo element 740. The piezo element 740 has a first split end 744 and a second split end 746. The first and second split ends 744, 746 extend from a portion 745 of the piezo element 740 toward the leading end 722 of the body 721. The first split end 744 is in mechanical communication with the first side 753 of the composite member 750. The second split end 746 is in mechanical communication with the second side 755 of the composite member 750. This is one possible configuration for the orientations of the piezo element 740 relative to the composite member 750, and variations thereof may be implemented.

The body 721 has a first outer surface 727 and a second outer surface 729. The second outer surface 729 is located opposite the first outer surface 727. The first and second outer surfaces 727, 729 refer to outer surfaces of the body 721 along a top and bottom side, respectively, of the body 721 as oriented in FIG. 8. The first and second outer surfaces 727, 729 may include portions of the leading and trailing ends 722, 724 and/or the leading and trailing edges 728, 725. In some embodiments, the boundaries of the first and second outer surfaces 727, 729 may be separated by a mean camber line of the blade 720. The first and second outer surfaces 727, 729, or portions thereof, may include a nylon skin.

The composite member 750 has a first prong 754 and a second prong 756. In some embodiments, the composite member 750 may have no prongs, only one prong, or more than two prongs. The first and second prongs 754, 756 extend from or near an end of the first portion 752 of the composite member 750 that is closer to the leading end 722 than to the trailing end 724. The first prong 754 extends toward the first outer surface 723 of the body 721. The second prong 756 extends toward the second outer surface 756 of the body 721. The first prong 754 of the composite member further extends toward the leading end 722 along the transverse length. For example, the first prong 754 may be coupled with a first segment 758 of the composite member 750 which may extend toward the trailing end 722 along the transverse length. The first segment 758 may be a continuation of the first prong 754. There may be an angle formed by the transition from the first prong 754 to the first segment 758. In some embodiments, the transition from the first prong 754 to the first segment 758 may be smooth, segmented, angled, other contours, or combinations thereof. In some embodiments, the first segment 758 extends toward the leading end 722 along the transverse length at a location that is closer to the first outer surface 727of the body 721 than to the second outer surface 729 of the body 721.

The second prong 756 of the composite member 750 further extends toward the leading end 722. For example, the second prong 756 may be coupled with a second segment 759 of the composite member 750 which may extend toward the trailing end 722 along the transverse length. The second segment 759 may be a continuation of the second prong 756. There may be an angle formed by the transition from the second prong 756 to the second segment 759. In some embodiments, the transition from the second prong 756 to the second segment 759 may be smooth, segmented, angled, other contours, or combinations thereof. In some embodiments, the second segment 759 extends toward the leading end 722 along the transverse length at a location that is closer to the second outer surface 729 of the body 721 than to the first outer surface 727 of the body 721.

The first and second prongs and segments 754, 756, 758, 759 may be generally linear. In some embodiments, the first and second prongs and segments 754, 756, 758, 759 may be linear, non-linear, segmented, other contours, or combinations thereof. The first and second prongs 754, 756 may be symmetric or asymmetric with respect to a mean camber line defined by the body 721. The first and second segments 758, 759 may be symmetric or asymmetric with respect to a mean camber line defined by the body 721. The first and second segments 758, 759 may be closer to a mean camber line defined by the body 721 than to, respectively, the first and second outer surfaces 727, 729. The first and second segments 758, 759 may taper, e.g. become thinner, along a length from the first and second prongs 754, 756 to ends of the first and second segments 758, 759 at or near the leading end 722. In some embodiments, the thickness of the composite member 750 may be uniform. In some embodiments, the thickness of the composite member 750 may vary along the length of the various portions thereof.

The blade 720 may have a foam core 770. The foam core 770 may be located at least partially within the leading end 722. The foam core 770 may be located at least partially in between the first and second segments and/or prongs 758, 759, 754, 756 of the composite member 750. The foam core 770 may contact the first and second segments and/or prongs 758, 759, 754, 756. The foam core 770 generally maintains its shape when the blade 720 is in the first or second shapes. In some embodiments, the foam core 770 may change shapes when the blade 720 is in the first or second shapes. The foam core may be a variety of suitable foams, e.g. polyethylene, polyurethane, etc.

The blade 720 may have one or more metallic honeycomb members 760. As shown, the blade 720 may have a first metallic honeycomb member 762 and a second metallic honeycomb member 764. The first and second metallic honeycomb members 762, 764 may be located at or near the trailing end 724 of the blade 720. The first and second metallic honeycomb members 762, 764 may be located opposite each other as shown, for example separated by the composite member 750 and/or the piezo element 740. Part of the first metallic honeycomb member 762 may be located in between the first outer surface 727 of the body 721 and the piezo element 740. The first and/or second metallic honeycomb members 762, 764 may deform when the blade 720 changes from a first shape to a second shape, or to a third shape, etc. Some or all of the first and/or second metallic honeycomb members 762, 764 may deform due to induced shaped changes from applying a current to the piezo element 740. In some embodiments, the first and/or second metallic honeycomb members 762, 764 may not deform when the blade 720 changes shape.

Part of the first metallic honeycomb member 762 may be located in between the first outer surface 727 of the body 721 and the composite member 750, e.g. the first portion 752, first prong 754, and/or the first segment 758 of the composite member 750. The first metallic honeycomb member 762 may extend to the trailing edge 725 of the blade 720.

Part of the second metallic honeycomb member 764 may be located in between the second outer surface 729 of the body 721 and the piezo element 740. Part of the second metallic honeycomb member 764 may be located in between the second outer surface 729 of the body 721 and the composite member 750, e.g. the first portion 752, second prong 754, and/or the second segment 759 of the composite member 750. The second metallic honeycomb member 764 may extend to the trailing edge 725 of the blade 720.

The blade 720 may include a spar 780. The spar 780 is a structural member that provides rigidity to the blade 720. The spar 780 may be formed of metals, composites, other suitable materials, or combinations thereof. The spar 780 is located at least partially at the leading end 722. The spar 780 may form a portion of the body 721. The spar 780 may form portions of the first and/or second outer surfaces 727, 729. The spar may extend along the first outer surface 727 to the leading edge 728 and along the second outer surface 729. The spar 780 may be located entirely or partially along the outside of the blade 720. The spar 780 may have the open cross-sectional shape as shown. In some embodiments, the spar 780 may be located entirely or partially inside the blade 720, and/or have a closed cross-sectional shape, for example as shown in FIG. 9.

FIGS. 8A and 8B are graphical representations showing, respectively, embodiments of blade chord distributions and blade twist distributions that may be incorporated into the shape-changing aircraft blades described herein. As shown in FIG. 8A, the chord or transverse distance of the blade is shown on the vertical axis. The spanwise station, or longitudinal distance “r” along the length of the blade as a ratio of the entire span or longitudinal length of the blade “R,” is shown on the horizontal axis. The chord may have different distributions along the span of the blade for different types of blades and/or activities. Embodiments of distributions for “hover,” “loiter,” and “blended variable pitch blades” are shown. The hover and variable pitch distribution of chord may be longer relative to the loiter distribution up to about 0.7 spanwise station, after which the distributions may be similar or approximately similar to the tip of the blade where r/R=1. This is merely one example and other values and/or relationships may be used. In some embodiments, the blades described herein may have one or more of the chord distributions shown, for example the blade 700 of FIGS. 7A-7F.

As shown in FIG. 8B, various embodiments of example blade twist distributions are shown for various types of blades and/or activities. The twist of the blade is shown on the vertical axis as an angle of twist β in degrees. The spanwise station, similar to that of FIG. 8A, is shown on the horizontal axis. Distributions of twist are shown for a hover, loiter, blended hover variable pitch and blended cruise variable pitch. The loiter has the largest twist and the blended cruise variable pitch the second largest twist up to about 0.6 spanwise station, after which the two are similar or approximately similar to the tip of the blade where r/R=1. The twist distributions for the hover and blended hover variable pitch are smaller than that of the loiter and the blended cruise variable pitch. The twist distributions for the hover and blended hover variable pitch are approximately the same, with some slight deviations around 0.6 and after about 0.8 spanwise stations. These are merely some examples and other values and/or relationships may be used. In some embodiments, the blades may rotate to uniformly alter the pitch and/or change shape to induce a different twist in the blade according to the various distributions shown and/or other distributions. In some embodiments, the blades described herein may have one or more of the twist distributions shown, for example the blade 700 of FIGS. 7A-7F.

FIG. 9 is a partial perspective view of another embodiment of a shape-changing blade 720′ with some components removed for clarity. The “longitudinal directions” and “transverse directions” double-sided arrows are indicated, showing the dimensions along which the terms “longitudinal length” and “transverse length” of the blade 720′ refers, respectively, as used herein. The blade 720′ may have some of the same or similar features and/or functionalities as the blade 720, and vice versa. The blade 720′ may also include the foam core 770 and/or the metallic honeycomb member 760.

The blade 720′ includes the composite member 750, including the first portion 752, the first prong 754, the second prong 756, the first segment 758, and the second segment 759. The blade 720 includes a spar 780′. The spar 780′ may have some of the same or similar features and/or functionalities as the spar 780, and vice versa. The spar 780′ is located at least partially within the body 721 of the blade 720′. As shown the spar 780′ has a closed cross-sectional shape and extends partially within the composite member 750. For example, the spar 780′ may extend between the first and second segments 758, 759 of the composite member 750. In some embodiments, the spar 780′ may extend at least partially between the first and second prongs 754, 756 of the composite member 750.

The blade 720′ includes a piezo element 740′. The piezo element 740′ may have some of the same or similar features and/or functionalities as the piezo element 740, and vice versa. The piezo element 740′ includes first, second and third segments 740A, 740B and 740C, respectively. The first, second and third segments 740A, 740B, 740C may be portions of a piezo material. The first, second and third segments 740A, 740B, 740C may be plies of piezo material. The first, second and third segments 740A, 740B, 740C may all be the same type of piezo material. In some embodiments, some or all of the first, second and third segments 740A, 740B, 740C may be different types of piezo materials.

The first, second and third segments 740A, 740B, 740C may be partially overlapping as shown, or otherwise have different locations along the transverse length of the body 721. The first, second and third segments 740A, 740B, 740C may be attached to, for example bonded with, the composite member 750 at various locations. As shown, the first segment 740A may be attached to the first side 753 of the composite member 750. The first segment 740 may extend along the longitudinal length of the blade 720′.

The second segment 740B may be located closer to the trailing end 724 than the first segment 740A. The second segment 740B may be attached to the first side 753 of the composite member 750 at a location closer to the trailing end 724 than the attachment of the first segment 740A. The second segment 740B may extend along the longitudinal length of the blade 720′.

The third segments 740C may be located closer to the trailing end 724 than the first and second segments 740A, 740B. The third segments 740C may be attached to the first side 753 of the composite member 750 at a location closer to the trailing end 724 than the attachment of the first and second segments 740A, 740B. The third segments 740C may be adjacent each other along the longitudinal length of the blade 720′. The third segments 740C may be separated from each other forming spaces between adjacent third segments 740C.

In some embodiments, the blade 720′ may include a second piezo element 740′ (not shown in FIG. 9), which may be located opposite the first piezo element 740′ along the second side 755 of the composite member 750.

FIG. 10A is a schematic of the shape-changing aircraft blade 720 for illustration of various control techniques. Portions of the blade 720 are shown which may have their shape changed for the various control techniques. The blade 720 is connected to a hub 710. The blade 720 includes a coincident lag-flap hinge 712 and a pitch bearing 714. The pitch bearing 714 may include a pitch spring and a root pitch index (RPI) setting. The hinge 712 and pitch bearing 714 may be adjusted to control the amount of pitch in the blade 720. The hinge 712 and pitch bearing 714 may be adjusted to control the initial angle of the blade 720 near the root of the blade 720, e.g. near the hub 710. Setting the pitch of the blade 720 may alter how the piezo element 740 changes the pitch of the blade, e.g. the amount of change in pitch or the final pitch induced by applying current to the piezo element 740.

The blade 720 may provide cyclic control or collective continuous trailing edge flap (CTEF) control. Cyclic control changes the pitch angle of the aircraft blade 720 cyclically, for example at one or more angular locations or angular ranges of the path of the blade 720 as it rotates. The pitch of the blade 720 thus changes depending upon its position as it rotates. The pitch of the blade 720 may be changed within an angular range of rotational positions. The pitch of the blade 720 may vary depending on the angular location. By changing the pitch angle of the blade 720 by different amounts at different angular locations of rotation, there is a net effect to tilt the “disc” that the blade 720 sweeps out as it rotates. The disc moves in the direction of tilt and the aircraft 100 then follows. The change in cyclic pitch has the effect of changing the angle of attack of the blade 720.

Cyclic control may change the shape of a portion 721B of the blade 720 and thus the pitch of the portion 721B. The shape of the portion 721B may be changed by using the piezo element 740, for example by placing the piezo element 740 in that location or supplying current to a portion of the piezo element 740 in that location. The portion 721B may be located between about 0.825 R and 1 R from the center of the hub 710, where 1 R is the longitudinal length of the blade 720 from the center of the hub 710 to the outer end 721 of the blade 720.

Cyclic controls may adjust forward speed and control a rolled-turn of the aircraft 100. Cyclic controls may create movement sideways and induce roll of the aircraft 100 in the direction moved. Cyclic control may thus be used to perform the horizontal-to-vertical and vertical-to-horizontal rotations of the aircraft 100 described herein.

Cyclic control may be applied to multiple blades of the same blade assembly, such as to the blades 212, 214, 216 of the blade assembly 210. For example, the blades 212, 214, 216 may each have their pitch changed at the same angular locations of rotation, such that each blade has the same pitch at a given angular location of rotation. The blades 212, 214, 216 may thus each have different pitches at a given moment in time.

Collective control changes the pitches of all blades collectively, such as the blade 720 or blades 212, 214, 216. The pitch angles of all blades 212, 214, 216 changes at the same time and independent of their rotational position. Collective control may change the shape of a portion 721A of the blade 720. The portion 721A may be located between about 0.70 R and 0.825 R from the center of the hub 710. Collective control may be used to adjust propulsive forces produced by the blade assembly 210.

FIG. 10B is a schematic of various control techniques that may be used with the aircraft 100. The “helicopter mode” control techniques may be used when the aircraft is in the vertical takeoff and landing phases. The “airplane mode” control techniques may be used when the aircraft is in the horizontal flight phases. The various effects on the aircraft 100 may be applied, including thrust, roll, pitch and yaw, as indicated. The arrows indicated the direction of force or moment applied to the aircraft 100 for the particular control technique identified. The shape-changing blades described herein may be used for various helicopter mode control techniques as shown, including common mode collective pitch, differential collective pitch control, cyclic pitch control, and differential cyclic pitch control, as well as the airplane mode technique of differential collective pitch control. In some embodiments, control surfaces of the aircraft 100 may be used for the airplane mode controls, in addition or alternatively to the shape-changing blades. For example, control surfaces may be used as shown for the differential elevon control, common elevon control, differential collective pitch control, and rudder control.

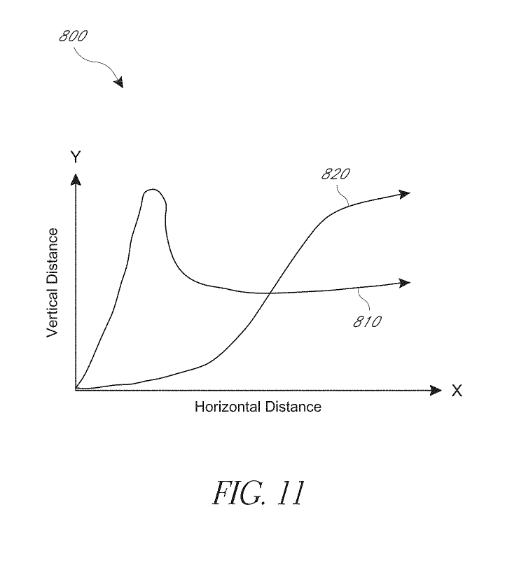

FIG. 11 is a plot 800 showing an embodiment of a flight profile 810 for the tail-sitter aircraft 100. The flight profile 810 shows an embodiment of a flight profile for the tail-sitter aircraft 100 where the aircraft 100 has vertical and horizontal flight phases. For comparison, the flight profile 820 for a typical horizontal takeoff aircraft is shown. The Y-axis of the plot 800 shows vertical distance of the aircraft. The X-axis of the plot 800 shows horizontal distance of the aircraft.

The flight profile 810 shows that the aircraft 100 may initially takeoff vertically and fly vertically to a maximum vertical distance (vertical flight phase), drop back downward, and then settle at a lower vertical distance for continued horizontal flight (horizontal flight phase). The aircraft 100 may therefore use a “dive” or similar profile to rotate the aircraft 100 from vertical to horizontal. The initial slope of flight profile 810 is steeper than the initial slope of flight profile 820. The hybrid propulsion system 105 may supply maximum or peak power during this initial steep slope. In flight profile 810, the aircraft is increasing vertical distance initially without moving as far horizontally as the profile 820. As shown in flight profile 810, there may be some movement horizontally as the aircraft 100 takes off. After the aircraft 100 rotates to enter the horizontal flight phase, the hybrid propulsion system 105 may provide a lower amount of power, as described.

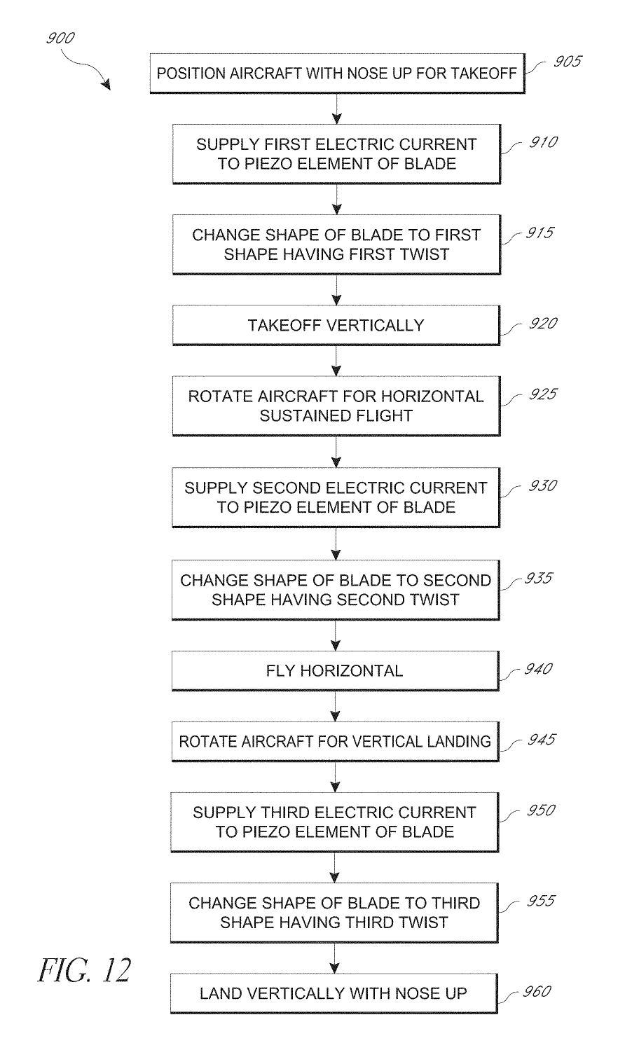

FIG. 12 is a flowchart showing an embodiment of a method 900 for operating the shape-changing aircraft blades of the tail-sitter aircraft 100 in flight. While described with respect to particular aircraft and blades, the method 900 may be performed with the various aircraft and blades described herein, such as the aircraft 100 and blades 212, 214, 216, 720, 720′, etc.

The method 900 begins with step 905 wherein the aircraft 100 is positioned with the nose up for vertical takeoff. The step 905 may include, for example, positioning the aircraft 100 on its tails 180, 190 and/or on other structures for vertical takeoff. The aircraft 100 may be positioned in a variety of suitable ways, including landing on the tail from a prior flight, positioned by humans and/or machines, etc. In step 905 the nose may be pointing vertically or off-vertically.

The method 900 then moves to step 910 wherein a first electric current is supplied to a piezo element of a blade of the aircraft 100. Step 910 may include, for example, applying the first electric current from an energy store to the piezo element 740. The first electric current may induce a deformation of the piezo element 740 in step 910.

The method 900 then moves to step 915 wherein the shape of the blade is changed to a first shape having a first twist. Step 915 may include, for example, the piezo element 740 embedded in the blade 720 inducing a twist in the blade 720, thus altering the pitch of the blade 720. The twist may non-uniformly or uniformly change the pitch along the longitudinal or spanwise direction of the blade. In some embodiments, in step 915 the entire blade may be rotated, for example about the blades longitudinal axis, to uniformly change the pitch along the blade by a similar amount. In some embodiments, in step 915 a different twist may be induced and the blade may be rotated. Various distributions of twist and/or pitch may be used, such as those shown in FIG. 8B.

The method 900 then moves to step 920 wherein the aircraft 100 takes off vertically. The step 920 may include, for example, rotating the blade assemblies 210 at a speed and pitch which creates sufficient lift for the aircraft 100 to take off vertically. During vertical flight, the blades may act like an efficient rotor, which may provide cyclic or collective control. Step 920 may include the vertical flight phase, as described herein. The aircraft 100 in step 920 may have a trajectory where the longitudinal axis of the aircraft 100 may or may not be aligned with a geographic vertical or line of action of gravity.

The method 900 then moves to step 925 wherein the aircraft 100 is rotated for horizontal flight. Step 925 may include rotating the aircraft using cyclic control, falling or diving to rotate to horizontal using control surfaces, etc. Step 925 may include, for example, rotating the aircraft 100 such that the longitudinal axis of the aircraft 100 is generally horizontal. The aircraft 100 may have trajectories where the Z axis of the aircraft 100 may or may not be aligned with a geographic vertical or line of action of gravity.

The method 900 then moves to step 930 wherein a second electric current is supplied to the piezo element 740 of the blade 720 of the aircraft 100. Step 930 may include, for example, applying the second electric current from an energy store to the piezo element 740. The second electric current may induce a deformation of the piezo element 740 in step 930. In some embodiments, the second electric current is greater than or less than the first electric current.

The method 900 then moves to step 935 wherein the shape of the blade 720 is changed to a second shape having a second twist. The step 935 may include, for example, the piezo element 740 embedded in the blade 720 inducing a twist in the blade 720, thus altering the blade structure. In some embodiments, the second twist includes a distribution of pitches along the span of the blade that is greater than a first distribution of pitches along the span of the blade due to a first twist, such as the first twist induced in step 915. In some embodiments, the second twist causes the pitch to be about 20 degrees to 30 degrees greater at one or more locations along the span of the blade compared to a distribution of pitches due to a first twist. The second twist may non-uniformly or uniformly change the pitch along the longitudinal or spanwise direction of the blade. In some embodiments, in step 935 the entire blade may be rotated, for example about the blades longitudinal axis, to uniformly change the pitch along the blade by a similar amount. In some embodiments, in step 915 a different twist may be induced and the blade may be rotated. Various distributions of twist and/or pitch may be used, such as those shown in FIG. 8B.

The method 900 then moves to step 940 wherein the aircraft 100 flies horizontally. The step 940 may include the horizontal flight phase as described herein, for example where lift to the aircraft 100 is provided primarily from the wings and not primarily from the propellers. The speed of rotation of the blade 720 may also be changed in step 935, for example decreased.

The method 900 then moves to step 945 wherein the aircraft 100 is rotated for vertical landing. The step 945 may include, for example, rotating the aircraft 100 so that the longitudinal axis of the aircraft 100 is in the generally vertical direction with the tails 180, 190 pointed down to the ground. The aircraft 100 may be rotated in step 945 using cyclic controls, control surfaces, by flying upward, etc.

The method 900 then moves to step 950 wherein a third electric current is supplied to the piezo element 740 of the blade 720 of the aircraft 100. Step 950 may include, for example, applying the third electric current from an energy store to the piezo element 740. In some embodiments, the third electric current may be the same or substantially similar to the first electric current. In some embodiments, the third electric current may be greater than or less than the first electric current. The third electric current may induce a deformation of the piezo element 740 in step 930.

The method 900 then moves to step 955 wherein the shape of the blade 720 is changed to a third shape having a third twist. Step 955 may include, for example, the piezo element 740 embedded in the blade 720 inducing a twist in the blade 720, thus altering the blade structure. The third twist may be the same or substantially similar to the first twist. The third twist may be greater than or less than the first twist. By “less or greater” it is meant a pitch at a particular spanwise station is less or greater than the pitch at that same spanwise station after inducing a different twist. The difference between the first pitch corresponding to the first twist and the third pitch corresponding to the third twist, at a particular spanwise station, may be about 2 degrees or less. The third twist may include a third pitch distribution that is suitable for landing. The third twist may non-uniformly or uniformly change the pitch along the longitudinal or spanwise direction of the blade. In some embodiments, in step 955 the entire blade may be rotated, for example about the blades longitudinal axis, to uniformly change the pitch along the blade by a similar amount. In some embodiments, in step 955 a different twist may be induced and the blade may be rotated. Various distributions of twist and/or pitch may be used, such as those shown in FIG. 8B.

The method 900 then moves to step 960 wherein the aircraft 100 lands vertically with the nose up. Step 960 may include, for example, the longitudinal axis of the aircraft 100 in the generally vertical direction with the tails 180, 190 and/or other structures pointed down and touching down on the ground. The nose may be pointing vertically or off-vertically.

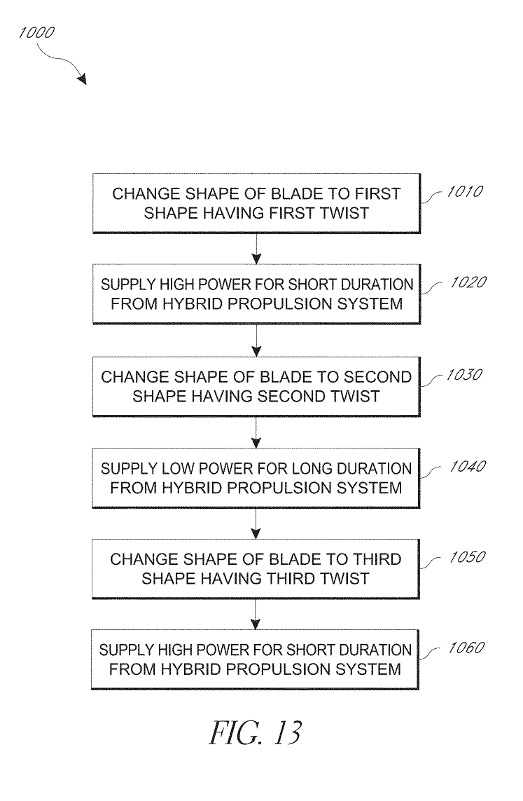

FIG. 13 is a flowchart showing an embodiment of a method 1000 for operating the hybrid propulsion system 105 and the shape-changing aircraft blade 720 of the tail-sitter aircraft 100 in flight. While described with respect to a particular aircraft, hybrid propulsion system and blades, the method 1000 may be performed with the various aircraft, hybrid propulsion systems and blades described herein, such as the aircraft 100, hybrid propulsion system 105 and blades 212, 214, 216, 720, 720′, etc.

The method 1000 begins with step 1010 wherein the shape of the blade 720 is changed to a first shape having a first twist. Step 1010 may be the same or similar to step 915 of the method 900 in FIG. 12.

The method 1000 then moves to step 1020 wherein a high power is supplied for a short duration from a hybrid propulsion system. Step 1020 may include, for example, providing high or peak power from the hybrid propulsion system 105 for takeoff. The power provided from the hybrid propulsion system 105 for takeoff is expected to be higher than the power provided from the hybrid propulsion system 105 for horizontal flight. The short duration of power provided for takeoff is expected to be shorter than the duration of power provided for horizontal flight. In some embodiments, the hybrid propulsion system 105 may provide the high power using the prime power subsystem 300A, 300B, 300C, 300D or 300E, the electrical power subsystem 200A, 200B, 200C, 200D or 200E, or a combination of the prime and electrical power subsystems. The high power provided is sufficient to lift the aircraft 100 from the ground. The short duration is sufficient to lift the aircraft 100 to a desired height.

The method 1000 moves to step 1030 wherein the shape of the blade 720 is changed to a second shape having a second twist. Step 1030 may be the same or similar to step 935 of the method 900 in FIG. 12.

The method 1000 then moves to step 1040 wherein a low power is supplied for a long duration from the hybrid propulsion system 105. The step 1040 may include, for example, providing low power from the hybrid propulsion system 105 for horizontal, sustained flight. The low power provided from the hybrid propulsion system 105 for horizontal flight is expected to be lower than the high power provided from the hybrid propulsion system 105 for takeoff. The long duration of power provided for horizontal flight is expected to be longer than the short duration of power provided for takeoff. In some embodiments, the hybrid propulsion system 105 may provide the low power using the prime power subsystem 300A, 300B, 300C, 300D or 300E, the electrical power subsystem 200A, 200B, 200C, 200D or 200E, or a combination of the prime and electrical power subsystems. The low power provided is sufficient to keep the aircraft 100 aloft. The long duration is sufficient for the aircraft to go a desired distance or desired amount of time.

The method 1000 then moves to step 1050 wherein the shape of the blade is changed to a third shape having a third twist. Step 1050 may be the same or similar to step 955 of the method 900 in FIG. 12.

The method 1000 then moves to step 1060 wherein a high power is supplied for a short duration from the hybrid propulsion system. Step 1060 may be similar to step 1020. Step 1060 may include, for example, providing high power from the hybrid propulsion system 105 for landing. The high power provided from the hybrid propulsion system 105 for landing is expected to be higher than the low power provided from the hybrid propulsion system 105 for horizontal flight. The short duration of power provided for landing is expected to be shorter than the long duration of power provided for horizontal flight. In some embodiments, the hybrid propulsion system 105 may provide the high power using the prime power subsystem 300A, 300B, 300C, 300D or 300E, the electrical power subsystem 200A, 200B, 200C, 200D or 200E, or a combination of the prime and electrical power subsystems. The high power provided is sufficient to lower the aircraft 100 to the ground. The short duration is sufficient for the aircraft 100 to land. The high power provided and short duration for landing may be the same or substantially similar to the high power provided and short duration for takeoff. In some embodiments, the high power provided and/or short duration for landing may be less than the high power and/or short duration for takeoff In some embodiments, the high power provided and/or short duration for landing may be greater than the high power and/or short duration for takeoff.

FIGS. 14A, 14B and 14C are side, top and front views, respectively, of another embodiment of an aircraft 100′ that may use the shape-changing blades and/or hybrid propulsion systems described herein. The aircraft 100′ may have the same or similar features and/or functionalities as the aircraft 100 described herein, and vice versa.

The aircraft 100′ includes a hybrid propulsion system 105′. The hybrid propulsion system 105′ may have the same or similar features and/or functionalities as the hybrid propulsion systems 105, 400A, 400B, 400C, 400D or 400E. The hybrid propulsion system 105′ includes two electric power subsystems 200′ and a prime power subsystem 300′. The electric power subsystem 200′ and prime power subsystem 300′ may have the same or similar features and/or functionalities as, respectively, the electric power subsystem 200A, 200B, 200C, 200D, or 200E and prime power subsystem 300A, 300B, 300C, 300D or 300E. There may be an additional electric power subsystem 200′, for example coupled with a rear blade assembly 210″. The bodies of the electric power subsystem 200′, the prime power subsystem 300′ and/or other structural portions of the aircraft 100′ may be part of the fuselage of the aircraft 100′

The aircraft 100′ may include two front blade assemblies 210′ and one rear blade assembly 210″. The blade assemblies 210′ and 210″ may have the same or similar features and/or functionalities as the blade assembly 210, and vice versa. The blade assemblies 210′ and 210″ may be part of the electric power subsystem 200′. The blade assemblies 210′ are located outboard of a prime power subsystem 300′ and the rear blade assembly 10″ is located rearward of the prime power subsystem 300′. The blade assemblies 210′ and 210″ provide forward propulsive forces to the aircraft 100′, i.e. lift during the vertical takeoff and landing flight phases, and thrust during the horizontal flight phase. The two front blade assemblies 210′ may have longer length blades compared to the rear blade assembly 210″. In some embodiments, the two front blade assemblies 210′ may have the same length or shorter length blades compared to the rear blade assembly 210″. The blades of the front blade assemblies 210′ and/or the rear blade assembly 210″ may include piezo elements, such as the piezo elements 740, to change shape, as described herein.

The aircraft 100′ includes two vertical tails 180′. The tails 180′ are angled, vertical segments extending from a rear portion of a center fuselage portion of the aircraft 100′. The tails 180′ provide a support and landing structure for the aircraft 100′. The tails 180′ may the same or similar features and/or functionalities as the other tails described herein, for example the tails 180, 190, etc. The aircraft 100′ may include supports 190′ located at or near the rear of the electric power subsystems 200′. The supports 190′ may provide support and balance to the aircraft 100′ while on the ground, during takeoff, during landing, etc. The vertical tails 180′ and the support 190′ provide four points of contact with the ground and a larger footprint for the aircraft 100′ for greater stability.

The aircraft 100′ may be operated using the various methods described herein, for example the methods 500, 600, 650, 900, 1000. The aircraft 100′ may include the various blade assemblies described herein, for example the blade assembly 700 and/or blade 720 or 720′.

While the above detailed description has shown, described, and pointed out novel features of the invention as applied to various embodiments, it will be understood that various omissions, substitutions, and changes in the form and details of the device or process illustrated may be made by those skilled in the art without departing from the spirit of the invention. As will be recognized, the present invention may be embodied within a form that does not provide all of the features and benefits set forth herein, as some features may be used or practiced separately from others. The scope of the invention is indicated by the appended claims rather than by the foregoing description. All changes which come within the meaning and range of equivalency of the claims are to be embraced within their scope.

The foregoing description details certain embodiments of the systems, devices, and methods disclosed herein. It will be appreciated, however, that no matter how detailed the foregoing appears in text, the systems, devices, and methods may be practiced in many ways. As is also stated above, it should be noted that the use of particular terminology when describing certain features or aspects of the invention should not be taken to imply that the terminology is being re-defined herein to be restricted to including any specific characteristics of the features or aspects of the technology with which that terminology is associated.

It will be appreciated by those skilled in the art that various modifications and changes may be made without departing from the scope of the described technology. Such modifications and changes are intended to fall within the scope of the embodiments. It will also be appreciated by those of skill in the art that parts included in one embodiment are interchangeable with other embodiments; one or more parts from a depicted embodiment may be included with other depicted embodiments in any combination. For example, any of the various components described herein and/or depicted in the Figures may be combined, interchanged or excluded from other embodiments.

The flow chart sequences are illustrative only. A person of skill in the art will understand that the steps, decisions, and processes embodied in the flowcharts described herein may be performed in an order other than that described herein. Thus, the particular flowcharts and descriptions are not intended to limit the associated processes to being performed in the specific order described.

With respect to the use of substantially any plural and/or singular terms herein, those having skill in the art may translate from the plural to the singular and/or from the singular to the plural as is appropriate to the context and/or application. The various singular/plural permutations may be expressly set forth herein for sake of clarity.

It will be understood by those within the art that, in general, terms used herein are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

All references cited herein are incorporated herein by reference in their entirety. To the extent publications and patents or patent applications incorporated by reference contradict the disclosure contained in the specification, the specification is intended to supersede and/or take precedence over any such contradictory material.

The term “comprising” as used herein is synonymous with “including,” “containing,” or “characterized by,” and is inclusive or open-ended and does not exclude additional, unrecited elements or method steps.

All numbers expressing quantities of ingredients, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present invention. At the very least, and not as an attempt to limit the application of the doctrine of equivalents to the scope of the claims, each numerical parameter should be construed in light of the number of significant digits and ordinary rounding approaches.

The above description discloses several methods and materials of the present invention. This invention is susceptible to modifications in the methods and materials, as well as alterations in the fabrication methods and equipment. Such modifications will become apparent to those skilled in the art from a consideration of this disclosure or practice of the invention disclosed herein. Consequently, it is not intended that this invention be limited to the specific embodiments disclosed herein, but that it cover all modifications and alternatives coming within the true scope and spirit of the invention as embodied in the attached claims.

What is claimed is:

1. A hybrid propulsion system for a tail-sitter aircraft, the system comprising:
a propeller configured to provide vertical lift to the aircraft during vertical takeoff and vertical landing phases and to provide horizontal thrust to the aircraft during a horizontal flight phase;
an electrical power subsystem coupled with the propeller and configured to supply increased electrical power to rotate the propeller at a first speed during the vertical takeoff and vertical landing phases and to supply reduced electrical power to rotate the propeller at a second speed during the horizontal flight phase, wherein the first speed is greater than the second speed;
an electrical energy store coupled with the electrical power subsystem and configured to provide electrical energy to the electrical power subsystem during the vertical takeoff and landing phases and to store electrical energy produced by the electrical power subsystem during the horizontal flight phase; and
a prime power subsystem coupled with the electrical power subsystem and configured to supply increased prime power to the electrical power subsystem during the vertical takeoff and vertical landing phases and to supply reduced prime power to the electrical power subsystem during the horizontal flight phase.

2. The hybrid propulsion system of claim 1, the electrical power subsystem comprising:
a generator coupled with the prime power subsystem; and
an electric motor coupled with the generator and with the propeller,
wherein the prime power subsystem is configured to provide prime power to the generator for production of increased electrical power, and
wherein the generator is configured to supply the increased electrical power to the electric motor to rotate the propeller at high speed during the vertical takeoff and vertical landing phases.

3. The hybrid propulsion system of claim 2, wherein the electrical energy store is coupled with the electric motor, and wherein the electrical energy store is configured to provide the increased electrical energy to the electric motor during the vertical takeoff and landing phases.

4. The hybrid propulsion system of claim 3, wherein the electrical energy store is coupled with the generator, and wherein the electrical energy store is configured to store electrical energy produced by the generator during the horizontal flight phase.

5. The hybrid propulsion system of claim 1, wherein the prime power subsystem is an internal combustion engine.

6. The hybrid propulsion system of claim 1, wherein the electrical power subsystem supplies a peak electrical power during the vertical takeoff and vertical landing phases.

7. The hybrid propulsion system of claim 1, wherein the prime power subsystem supplies a peak prime power during the vertical takeoff and vertical landing phases.

8. The hybrid propulsion system of claim 1, wherein the electrical and prime power subsystems are configured to collectively produce a first total output of power for liftoff that is at least two times a second total output of power produced for horizontal flight.

9. The hybrid propulsion system of claim 1, the electrical power subsystem comprising:
a generator coupled with the prime power subsystem; and
an electric motor coupled with the generator and with the propeller,
wherein the prime power subsystem is configured to provide prime power to the generator for production of increased electrical power,
wherein the generator is configured to supply the increased electrical power to the electric motor to rotate the propeller at the first speed during the vertical takeoff and vertical landing phases,
wherein the electrical energy store is coupled with the electric motor,
wherein the electrical energy store is configured to provide the increased electrical energy to the electric motor during the vertical takeoff and landing phases,
wherein the electrical energy store is coupled with the generator, and wherein the electrical energy store is configured to store electrical energy produced by the generator during the horizontal flight phase,
wherein the electrical power subsystem supplies a peak electrical power during the vertical takeoff and vertical landing phases,
wherein the prime power subsystem supplies a peak prime power during the vertical takeoff and vertical landing phases, and
wherein the electrical and prime power subsystems are configured to collectively produce a first total output of power for liftoff that is at least two times a second total output of power produced for horizontal flight.

10. The hybrid propulsion system of claim 1, wherein the propeller comprises a piezo element configured to receive an electric current to change the shape of a propeller blade based on the phase of flight.

11. The hybrid propulsion system of claim 10, wherein a twist defined by the blade is increased by the piezo element for horizontal flight relative to takeoff and landing.

12. The hybrid propulsion system of claim 9, wherein the propeller comprises a piezo element configured to receive an electric current to change the shape of a propeller blade based on the phase of flight, and wherein an increased twist of the blade is induced by the piezo element for horizontal flight relative to takeoff and landing.

13. A tail-sitter aircraft comprising:
a fuselage having a nose end and a tail end, the aircraft configured to be oriented on the ground with the nose end pointing away from the ground;
a wing coupled with the fuselage and configured to provide lift during a horizontal flight phase; and
a hybrid propulsion system comprising;
a propeller;
an electrical power subsystem coupled with the propeller and configured to supply increased electrical power during vertical takeoff and vertical landing phases and to supply reduced electrical power during the horizontal flight phase;
an electrical energy store coupled with the electrical power subsystem and configured to provide electrical energy to the electrical power subsystem and to store electrical energy produced by the electrical power subsystem; and
a prime power subsystem coupled with the electrical power subsystem and configured to supply increased prime power during the vertical takeoff and vertical landing phases and to supply reduced prime power during the horizontal flight phase.

14. The tail-sitter aircraft of claim 13, wherein the propeller is configured to provide vertical lift to the aircraft during the vertical takeoff and vertical landing phases and to provide horizontal thrust to the aircraft during a horizontal flight phase.

15. The tail-sitter aircraft of claim 13, wherein the electrical and prime power subsystems are configured to collectively rotate the propeller at a relatively higher speed during the vertical takeoff and vertical landing phases and to collectively rotate the propeller at a relatively lower speed during the horizontal flight phase.

16. The tail-sitter aircraft of claim 13, wherein the electrical energy store provides electrical energy during the vertical takeoff and landing phases and stores electrical energy during the horizontal flight phase.

17. The tail-sitter aircraft of claim 13, the electrical power subsystem comprising:
a generator coupled with the prime power subsystem; and
an electric motor coupled with the generator and with the propeller,
wherein the prime power subsystem is configured to provide prime power to the generator for production of increased electrical power, and
wherein the generator is configured to supply the increased electrical power to the electric motor to rotate the propeller at high speed during the vertical takeoff and vertical landing phases.

18. The tail-sitter aircraft of claim 17, wherein the electrical energy store is coupled with the electric motor, and wherein the electrical energy store is configured to provide the increased electrical energy to the electric motor during the vertical takeoff and landing phases.

19. The tail-sitter aircraft of claim 18, wherein the electrical energy store is coupled with the generator, and wherein the electrical energy store is configured to store electrical energy produced by the generator during the horizontal flight phase.

20. The tail-sitter aircraft of claim 13, wherein the electrical power subsystem supplies a peak electrical power during the vertical takeoff and vertical landing phases.

21. The tail-sitter aircraft of claim 20, wherein the prime power subsystem supplies a peak prime power during the vertical takeoff and vertical landing phases.

22. The tail-sitter aircraft of claim 13, wherein the electrical and prime power subsystems are configured to collectively produce a first total output of power for liftoff that is at least two times a second total output of power produced for horizontal flight.

23. A method of control for a tail-sitter aircraft, the method comprising:
supplying a first and second prime power from a prime power subsystem to an aircraft engine during, respectively, takeoff/landing and horizontal flight; and
supplying a first and second electric power from an electric power source to the aircraft engine during, respectively, takeoff/landing and horizontal flight,
wherein a first sum equal to the sum of the first prime and electric powers is greater than a second sum equal to the sum of the second prime and electric powers,
wherein the first sum is sufficient to provide vertical lift in an amount at least equal to a force due to gravity on the aircraft, and
wherein the second sum is sufficient to sustain horizontal flight.

24. The method of claim 23, wherein the first sum is at least two times larger than the second sum.

25. The method of claim 23, wherein the first sum is about 300 horsepower.

26. The method of claim 23, wherein the second sum is about 60 horsepower.

27. The method of claim 23, further comprising:
changing the shape of a propeller blade of the aircraft to a first twist for takeoff and landing; and
changing the shape of the propeller blade to a second twist for horizontal flight,
wherein the second twist is greater than the first twist.

28. The method of claim 27, wherein changing the shape of the propeller blade comprises supplying a current to a piezo element coupled with the blade.
